(19) United States
(12) Patent Application Publication
(10) Pub. No.: US 2013/0294242 A1
(43) Pub. Date: Nov. 7, 2013

(54) METHOD AND APPARATUS FOR TRANSMITTING PUSCH IN TRAFFIC ADAPTATION SYSTEM

(71) Applicant: SAMSUNG ELECTRONICS CO. LTD., Suwon-si (KR)

(72) Inventors: Zheng ZHAO, Beijing (CN); Yingyang LI, Beijing (CN); Shichang ZHANG, Beijing (CN)

(73) Assignee: Samsung Electronics Co. Ltd., Suwon-si (KR)

(21) Appl. No.: 13/886,653

(22) Filed: May 3, 2013

(30) Foreign Application Priority Data
May 4, 2012 (CN) 201210136950.8

(51) Int. Cl. H04W 72/12

(52) U.S. Cl. CPC H04W 72/1252
USPC 370/235

(57) ABSTRACT

A Physical Uplink Shared Channel (PUSCH) transmission method by a User Equipment (UE) in a traffic adaptation system is provided. The method includes receiving, from a base station, a Physical Downlink Control Channel (PDCCH) for scheduling PUSCH resources, obtaining an Uplink (UL)-Grant in the PDCCH, determining a reference uplink and downlink configuration of the scheduled PUSCH resources in the PDCCH, based on at least one of the bit value of a UL-Index or a UL-Downlink Assignment Index (DAI) in the UL-Grant, and a serial number of a subframe in which the UL-Grant is located, and transmitting PUSCH data on the scheduled PUSCH resources according to a timing relationship corresponding to the reference uplink and downlink configuration.

### PRIORITY

This application claims the benefit under 35 U.S.C. §119(a) of a Chinese patent application filed on May 4, 2012 in the Chinese Patent Office and assigned Serial No. 201210136950.8, the entire disclosure of which is hereby incorporated by reference.

### BACKGROUND OF THE INVENTION

1. Field of the Invention

The present invention relates to radio communication technologies. More particularly, the present invention relates to a Physical Uplink Shared Channel (PUSCH) transmission method in a traffic adaptation system when a Time Division Duplexing (TDD) uplink and downlink configuration of cell dynamically changes with uplink and downlink traffic.

2. Description of the Related Art

Long Term Evolution (LTE) technology supports a Frequency Division Duplexing (FDD) mode and a TDD mode.

FIG. 1 is a schematic diagram illustrating the frame structure of a TDD system of LTE according to the related art.

Referring to FIG. 1, in the TDD system, the length of each radio frame 100 is 10 ms, and each radio frame 100 is divided into two half frames 102 with the length of 5 ms. Each half frame 102 comprises 8 time slots 104 with the length of 0.5 ms and 3 special domains 106 (e.g., special subframes) with the length of 1 ms. The 3 special domains 106 comprise a Downlink Pilot Time Slot (DwPTS), a Guard Partition (GP) and an Uplink Pilot Time Slot (UpPTS). Each subframe is composed of two continuous time slots.

The transmission in the TDD system includes transmission from a base station to User Equipment (UE) (e.g., referred to as downlink transmission) and transmission from the UE to the base station (e.g., referred to as uplink transmission). According to the frame structure shown in FIG. 1, the uplink transmission and downlink transmission in each 10 ms share 10 subframes, and each subframe is allocated to the uplink transmission or the downlink transmission. The subframe allocated to the uplink transmission may be referred to as an uplink subframe, and the subframe allocated to the downlink transmission may be referred to as a downlink subframe. The TDD system supports 7 types of uplink and downlink configurations, as shown in Table 1. In the Table 1, “D” indicates downlink sub-frames, “U” indicates uplink sub-frames, and “S” indicates special sub-frames including the above 3 special domains.

TABLE 1

| serial | conversion | | | | | | | | | | |
|---|---|---|---|---|---|---|---|---|---|---|---|
| number of | point | subframe index | | | | | | | | | |
| configuration | period | 0 | 1 | 2 | 3 | 4 | 5 | 6 | 7 | 8 | 9 |
| 0 | 5 ms | D | S | U | U | U | D | S | U | U | U |
| 1 | 5 ms | D | S | U | U | D | D | S | U | U | D |
| 2 | 5 ms | D | S | U | D | D | D | S | U | D | D |
| 3 | 10 ms | D | S | U | U | U | D | D | D | D | D |
| 4 | 10 ms | D | S | U | U | D | D | D | D | D | D |
| 5 | 10 ms | D | S | U | D | D | D | D | D | D | D |
| 6 | 10 ms | D | S | U | U | U | D | S | U | U | D |

In order to increase the transmission rate of user, an LTE-Advanced (LTE-A) technology has been developed. The LTE-A TDD system and the LTE system have the same Hybrid Automatic Repeat Request (HARQ) transmission timing relationship. The HARQ transmission timing relationship in the LTE system and the LTE-A system will be illustrated hereinafter.

The HARQ transmission timing relation includes the timing relationship between a Physical Downlink Control Channel (PDCCH), a Physical Hybrid-ARQ Indicator Channel (PHICH) and a PUSCH. The base station implements the scheduling of PUSCH resources through transmitting a PDCCH to the UE. After receiving the PDCCH, the UE transmits uplink data in a PUSCH designated by the PDCCH. The base station receives the uplink data carried by the PUSCH, and transmits the HARQ-ACK information of the PUSCH to the UE in the PHICH.

First, the timing relationship from the PDCCH and the PHICH to the PUSCH in the LTE system and the LTE-A system is illustrated.

For the timing relationship from the PDCCH to the PUSCH, suppose the UE receives the PDCCH in a downlink subframe n, and the PDCCH controls a PUSCH in a uplink subframe n+k. The value of k is defined in Table 2-1. Specifically, for uplink and downlink configurations 1-6, the number of uplink subframes is smaller than the number of downlink subframes. A unique HARQ transmission timing relationship may be configured. In Table 2-1, the PUSCH may not be scheduled in one downlink subframe, or only the PUSCH in one uplink subframe is scheduled. For an uplink and downlink configuration 0, the number of uplink subframes is larger than the number of downlink subframes. The PDCCH in each downlink subframe needs to schedule the PUSCH in two uplink subframes. Accordingly, the PDCCH schedules the PUSCH in two uplink subframes through an Uplink-Index (UL-Index) technology. For example, when the UE receives the PDCCH in a downlink subframe 0, the UE schedules a PUSCH in an uplink subframe 4 and/or an uplink subframe 7. When the UE receives the PDCCH in a downlink subframe 1, the UE schedules a PUSCH in the uplink subframe 7 and/or an uplink subframe 8.

TABLE 2-1

| serial number | | | | | | | | | | |
|---|---|---|---|---|---|---|---|---|---|---|
| of | downlink subframe index n | | | | | | | | | |
| configuration | 0 | 1 | 2 | 3 | 4 | 5 | 6 | 7 | 8 | 9 |
| 0 | 4, 7 | 6, 7 | | | | 4, 7 | 6, 7 | | | |
| 1 | | 6 | | | 4 | | 6 | | | 4 |
| 2 | | | | 4 | | | | | 4 | |
| 3 | 4 | | | | | | | | 4 | 4 |
| 4 | | | | | | | | | 4 | 4 |
| 5 | | | | | | | | | 4 | |
| 6 | 7 | 7 | | | | 7 | 7 | | | 5 |

For the timing relationship from the PHICH to the PUSCH, in the LTE system and the LTE-A system, the PUSCH in each uplink subframe is allocated with a PHICH resource set. Suppose the UE receives the PHICH in the downlink subframe n, and the PHICH controls the PUSCH in the uplink subframe n+k. The value of k is defined in Table 2-2. Specifically, for the uplink and downlink configurations 1-6, the number of uplink subframes is smaller than the number of downlink subframes. A unique HARQ transmission timing relationship may be configured. In Table 2-2, the PHICH resource set may not be configured in one downlink subframe, or only the PHICH resource set in one uplink subframe is configured. For the uplink and downlink configuration 0, the number of uplink subframes is larger than the number of downlink subframes. Two PHICH resource sets are configured in downlink subframes 0 and 5, respectively. For example, when the UE receives the PHICH in the downlink subframe 0, the PUSCH in the uplink subframe 4 and/or the uplink frame 7 may be triggered.

TABLE 2-2

| serial number | downlink subframe index n | | | | | | | | | |
|---|---|---|---|---|---|---|---|---|---|---|
| of configuration | 0 | 1 | 2 | 3 | 4 | 5 | 6 | 7 | 8 | 9 |
| 0 | 4, 7 | 7 | | | | 4, 7 | 7 | | | |
| 1 | | 6 | | | 4 | | 6 | | | 4 |
| 2 | | | | 4 | | | | | 4 | |
| 3 | 4 | | | | | | | | 4 | 4 |
| 4 | | | | | | | | | 4 | 4 |
| 5 | | | | | | | | | 4 | |
| 6 | 7 | 7 | | | | 7 | 7 | | | 5 |

Second, the timing relationship from the PUSCH to the PHICH in the LTE system and the LTE-A system is illustrated.

For the uplink and downlink configurations 1-6, when the UE receives the PHICH in a downlink subframe i, the PHICH indicates the ACK/NACK of PUSCH in an uplink subframe i-k, where the value of k is as shown in Table 2-3.

For the uplink and downlink configuration 0, when the UE receives the PHICH on the 0th PHICH resource in the downlink subframe i, the PHICH controls the PUSCH in the uplink subframe i-k. When the UE receives the PHICH on the 1st PHICH resource in the downlink subframe 0 or downlink subframe 5, the PHICH controls the PUSCH in an uplink subframe i-6.

TABLE 2-3

| uplink and | downlink subframe index n | | | | | | | | | |
|---|---|---|---|---|---|---|---|---|---|---|
| downlink configuration | 0 | 1 | 2 | 3 | 4 | 5 | 6 | 7 | 8 | 9 |
| 0 | 7 | 4 | | | | 7 | 4 | | | |
| 1 | | 4 | | | 6 | | 4 | | | 6 |
| 2 | | | | 6 | | | | | 6 | |
| 3 | 6 | | | | | | | | 6 | 6 |
| 4 | | | | | | | | | 6 | 6 |
| 5 | | | | | | | | | 6 | |
| 6 | 6 | 4 | | | | 7 | 4 | | | 6 |

According to the above tables (e.g., Table 2-2 and Table 2-3) showing three kinds of timing relationships, the synchronous HARQ timing relationship of PUSCH may be determined when a cell applies a certain TDD uplink and downlink configuration, so as to implement the synchronous transmission of PUSCH according to the synchronous HARQ timing relationship of PUSCH.

Because of the increasing requirements of the user on data transmission rate (e.g., an increasing demand for higher data transmission rates), in a higher version of LTE, a traffic adaptation TDD technology has been put forward. Through dynamically adjusting the ratio between uplink subframes and downlink subframes, the current uplink and downlink configuration more accords with the ratio between the current uplink traffic and downlink traffic, so as to improve the uplink and downlink peak rate of user and system throughput.

According to the specification of LTE and LTE-A protocol according to the related art, the UE obtains the TDD uplink and downlink configuration of the current cell through system messages broadcasted in the cell. The shortest update period of a system message is 640 ms. In the traffic adaptation TDD system, it is needed to implement the rapid switching of TDD uplink and downlink configuration. However, the switching period of the TDD uplink and downlink configuration in the LTE and LTE-A protocol according to the related art is not able to meet the rapid switching requirements of the traffic adaptation system.

For the traffic adaptation system, the synchronous HARQ timing relationship of PUSCH may not be obtained through the TDD uplink and downlink configuration according to the method of the related art.

Therefore, a need exists for a PUSCH transmission method, which can adapt to the rapid switching of TDD uplink and downlink configuration in a traffic adaptation system.

The above information is presented as background information only to assist with an understanding of the present disclosure. No determination has been made, and no assertion is made, as to whether any of the above might be applicable as prior art with regard to the present invention.

### SUMMARY OF THE INVENTION

Aspects of the present invention are to address at least the above-mentioned problems and/or disadvantages and to provide at least the advantages described below. Accordingly, an aspect of the present invention is to provide a PUSCH transmission method, which can adapt to the rapid switching of TDD uplink and downlink configuration in a traffic adaptation system.

According to an aspect of the present invention, a PUSCH transmission method is provided. The method includes checking, by User Equipment (UE), a Physical Downlink Control Channel (PDCCH) for scheduling PUSCH resources that is transmitted by a base station, obtaining an Uplink-Grant (UL-Grant) in the PDCCH; carrying a reference uplink and downlink configuration of the scheduled PUSCH in the PDCCH via a bit value of UL-Index or UL-Downlink Assignment Indicator (UL-DAI) in the UL-Grant and/or a serial number of a subframe where the UL-Grant is located, and determining, by the UE, the reference uplink and downlink configuration of the scheduled PUSCH resources according to the bit value of the obtained UL-Index or UL-DAI and/or the serial number of the subframe where the UL-Grant is located, and transmitting PUSCH data on the scheduled PUSCH resources according to a timing relationship corresponding to the reference uplink and downlink configuration.

According to another aspect of the present invention, the method further includes predefining four types of reference uplink and downlink configurations, wherein a first type of reference uplink and downlink configuration corresponds to a type I of uplink and downlink configuration 0, and the type I corresponds to a scheduling mode of the uplink and downlink configuration 0, a second type of reference uplink and downlink configuration corresponds to uplink and downlink configurations 1-5, a third type of reference uplink and downlink configuration corresponds to uplink and downlink configuration 6, a fourth type of reference uplink and downlink configuration corresponds to a type II of uplink and downlink configuration 0, and the type II corresponds to another scheduling mode of the configuration 0.

According to another aspect of the present invention, the method further includes carrying one of the four types of reference uplink and downlink configurations when carrying the reference uplink and downlink configuration via the bit value of the UL-Index or UL-DAI in the UL-Grant and/or the serial number of the subframe where the UL-Grant is located.

According to another aspect of the present invention, the method further includes configuring four values of the bits in UL-Index or UL-DAI to respectively correspond to the predefined four types of reference uplink and downlink configurations; wherein the determining of the reference uplink and downlink configuration of the scheduled PUSCH includes determining, by the UE according to a relationship between bit value of the obtained UL-Index or UL-DAI and the uplink and downlink configuration wherein the reference uplink and downlink configuration corresponding to the bit value is the reference uplink and downlink configuration of the scheduled PUSCH.

According to another aspect of the present invention, the method further includes wherein the determining of the reference uplink and downlink configuration of the scheduled PUSCH includes if the UL-Grant is in the 0th, 1st, 5th or 6th subframe, configuring four values of the bits in the UL-Index or UL-DAI to respectively correspond to the predefined four types of reference uplink and downlink configurations, and determining, by the UE according to the relationship between the bit value of the obtained UL-Index or UL-DAI and uplink and downlink configuration, wherein the reference uplink and downlink configuration corresponding to the bit value corresponds to the reference uplink and downlink configuration of the scheduled PUSCH, if the UL-Grant is in the 3rd, 4th or 8th subframe, determining that the reference uplink and downlink configuration is the configurations 1-5, and if the UL-Grant is in the 9th subframe, when the bit value of the UL-Index or UL-DAI is a predefined first value, determining that the reference uplink and downlink configuration is the uplink and downlink configuration 6, and when the bit value of the UL-Index or UL-DAI is not the predefined first value, determining that the reference uplink and downlink configuration is the uplink and downlink configurations 1˜5.

According to another aspect of the present invention, the scheduling mode of the configuration 0 corresponding to the type I of the configuration 0 includes scheduling a PUSCH of the (n+k)th subframe to the UE, wherein n is a downlink subframe for transmitting the PDCCH, and the value of k is determined according to a following table:

| serial | downlink subframe index n | | | | | | | | | |
|---|---|---|---|---|---|---|---|---|---|---|
| number of configuration | 0 | 1 | 2 | 3 | 4 | 5 | 6 | 7 | 8 | 9 |

| | | | | |
|---|---|---|---|---|
| 0 | 4 | 6 | 4 | 6 |

According to another aspect of the present invention, the scheduling mode of the configuration 0 corresponding to the type II of the configuration 0 includes scheduling a PUSCH of the (n+7)^{th} subframe to the UE.

According to another aspect of the present invention, the scheduling mode of the configuration 0 corresponding to the type I of the configuration 0 includes scheduling a PUSCH of the (n+k)^{th} subframe to the UE, and the scheduling mode of the configuration 0 corresponding to the type II of the configuration 0 includes scheduling a PUSCH of the (n+k)^{th} and the (n+7)^{th} subframes to the UE, wherein n is a downlink subframe for transmitting the PDCCH, and the value of k is determined according to a following table:

| serial | downlink subframe index n | | | | | | | | | |
|---|---|---|---|---|---|---|---|---|---|---|
| number of configuration | 0 | 1 | 2 | 3 | 4 | 5 | 6 | 7 | 8 | 9 |

| | | | | |
|---|---|---|---|---|
| 0 | 4 | 6 | 4 | 6 |

According to another aspect of the present invention, the scheduling mode of the configuration 0 corresponding to the type I of the configuration 0 includes scheduling a PUSCH of the (n+k)^{th} subframe to the UE.

According to another aspect of the present invention, the scheduling mode of the configuration 0 corresponding to the type II of the configuration 0 includes, when n=0 or 5, scheduling a PUSCH of the (n+k)^{th} and the (n+7)^{th} subframes to the UE, and when n=1 or 6, scheduling a PUSCH of the (n+k)^{th} and (n+6)^{th} subframes to the UE, wherein n is a downlink subframe for transmitting the PDCCH, and the value of k is determined according to a following table:

| serial number of | downlink subframe index n | | | | | | | | | |
|---|---|---|---|---|---|---|---|---|---|---|
| configuration | 0 | 1 | 2 | 3 | 4 | 5 | 6 | 7 | 8 | 9 |
| 0 | 4 | 7 | | | | 4 | 7 | | | |

According to another aspect of the present invention, the timing relationship corresponding to the second type of reference uplink and downlink configuration corresponds to transmitting the PUSCH on the (n+k)^{th} subframe, and wherein n is a downlink subframe for transmitting the PDCCH, and the value of k is determined according to a following table:

| serial | downlink subframe index n | | | | | | | | | |
|---|---|---|---|---|---|---|---|---|---|---|
| number of configuration | 0 | 1 | 2 | 3 | 4 | 5 | 6 | 7 | 8 | 9 |
| 1~5 | 4 | 6 | | 4 | 4 | | 6 | | 4 | 4 |

According to another aspect of the present invention, the timing relationship corresponding to the third type of reference uplink and downlink configuration is transmitting the PUSCH on the (n+k)^{th} subframe, and wherein n is a downlink subframe for transmitting the PDCCH, and the value of k is determined according to a following table:

| serial | downlink subframe index n | | | | | | | | | |
|---|---|---|---|---|---|---|---|---|---|---|
| number of configuration | 0 | 1 | 2 | 3 | 4 | 5 | 6 | 7 | 8 | 9 |

| | | | | | |
|---|---|---|---|---|---|
| 6 | 7 | 7 | 7 | 7 | 5 |

According to another aspect of the present invention, if the UL-Grant is in the 3rd, 4th or 8th subframe, the bit value of the UL-Index or the UL-DAI is used for indicating the number of Physical Downlink Shared Channel (PDSCH) transmission subframes to be returned by the subframe where the PUSCH is located, and if the UL-Grant is in the 9th subframe, and the bit value of the UL-Index or the UL-DAI is not the first value, the bit value of the UL-Index or the UL-DAI is used for indicating the number of PDSCH transmission subframes to be returned by the subframe where the PUSCH is located.

According to another aspect of the present invention, the method further includes determining, by the UE according to the reference uplink and downlink configuration, a timing relationship from the PUSCH to a Physical Hybrid-ARQ Indicator Channel (PHICH), receiving, according to the timing relationship, the PHICH or an UL Grant for indicating retransmission that is transmitted by the base station according to the timing relationship; when detecting the UL-Grant in the PHICH subframe, and when a new data indication bit of the UL-Grant indicates “changed”, returning, by the UE, to the step b); if the new data indication bit of the UL-Grant indicates “unchanged”, determining the reference uplink and downlink configuration of the scheduled PUSCH in the PDCCH, wherein the UL-Index or UL-DAI is the UL-Index or UL-DAI in the UL Grant for indicating retransmission, and the UL-Grant for indicating retransmission, is the UL Grant for indicating retransmission, and transmitting PUSCH data to be retransmitted when transmitting the PUSCH data, and when detecting “NACK” in the PHICH subframe, determining a timing relationship from the PHICH to the PUSCH according to the reference uplink and downlink configuration, and retransmitting the PUSCH data according to the timing relationship from the PHICH to the PUSCH.

According to another aspect of the present invention, when the PHICH subframe corresponds to two old PUSCHs in different uplink subframes, and the new data indication bit of the UL-Grant that is located in the same subframe as the PHICH indicates “unchanged”, if the reference uplink and downlink configuration determined is the same as that determined when one of the old PUSCHs is scheduled, the retransmitted PUSCH data is data of the old PUSCH.

According to another aspect of the present invention, a User Equipment (UE) for transmitting a Physical Uplink Shared Channel (PUSCH) in a traffic adaptation system is provided. The UE includes a receiver for receiving, from a base station, a Physical Downlink Control Channel (PDCCH) for scheduling PUSCH resources, a controller for obtaining an Uplink (UL)-Grant in the PDCCH, and determining a reference uplink and downlink configuration of the scheduled PUSCH resources in the PDCCH, based on at least one of the bit value of a UL-Index or a UL-Downlink Assignment Index (DAI) in the UL-Grant, and a serial number of a subframe in which the UL-Grant is located, when detecting the UL-Grant in the PHICH subframe, and when a new data indication bit of the UL-Grant indicates one of “changed” and “unchanged”, determining the reference uplink and downlink configuration of the scheduled PUSCH in the PDCCH, wherein the UL-Index or the UL-DAI is the UL-Index or the UL-DAI in the UL Grant for indicating retransmission, and the UL-Grant is the UL Grant for indicating retransmission, and transmitting PUSCH data to be retransmitted when transmitting the PUSCH data, and when detecting “NACK” in the PHICH subframe, determining a timing relationship from the PHICH to the PUSCH according to the reference uplink and downlink configuration, and retransmitting the PUSCH data according to the timing relationship from the PHICH to the PUSCH.

According to aspects of the present invention, in the traffic adaptation system, the UE may determine the synchronous HARQ timing relationship of the scheduled PUSCH according to the bit value of the UL-Index or UL-DAI in the received UL-Grant and/or the location of the UL-Grant. In the PUSCH transmission method of the present invention, the support of cell system messages is not needed, additional signaling indications of Radio Resource Control (RRC) layer are not needed, and the conventional format of PDCCH is not needed to be modified. And thus, the PUSCH transmission in the traffic adaptation system may be implemented as long as small system modification is made. At the same time, in the above method, the period that the UE receives the reference uplink and downlink configuration is decreased and thus has the same magnitude with the scheduling period of PUSCH, so that the UE can adapt to the rapid switching of the TDD uplink and downlink configuration.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a schematic diagram illustrating the frame structure of a Time Division Duplexing (TDD) system of Long Term Evolution (LTE) according to the related art;

FIG. 2 is a flowchart of a Physical Uplink Shared Channel (PUSCH) transmission method according to an exemplary embodiment of the present invention;

FIG. 3 is a schematic diagram illustrating a timing relationship of PUSCH scheduling that is determined according to a bit value of an Uplink (UL)-Index or a UL-DAI in a UL-Grant according to an exemplary embodiment of the present invention;

FIG. 4 is a schematic diagram illustrating a synchronous Hybrid Automatic Repeat Request (HARQ) timing relationship of PUSCH that is determined according to a location of a UL-Grant and illustrating a retransmission of PUSCH according to an exemplary embodiment of the present invention;

FIG. 5 is a schematic diagram illustrating an example that a PUSCH of two uplink subframes returns Physical HARQ Indicator Channels (PHICHs) or indicates retransmission in one downlink subframe according to an exemplary embodiment of the present invention;

FIG. 6 is a schematic diagram illustrating an example that a PUSCH of two uplink subframes indicates retransmission in one downlink subframe according to an exemplary embodiment of the present invention;

FIG. 7 is a schematic diagram illustrating an example in which a PUSCH of two uplink subframes indicates retransmission in one downlink subframe according to an exemplary embodiment of the present invention;

FIG. 8 is a block diagram illustrating a structure of a User Equipment (UE) according to an exemplary embodiment of the present invention; and

FIG. 9 is a block diagram illustrating a structure of a base station according to an exemplary embodiment of the present invention.

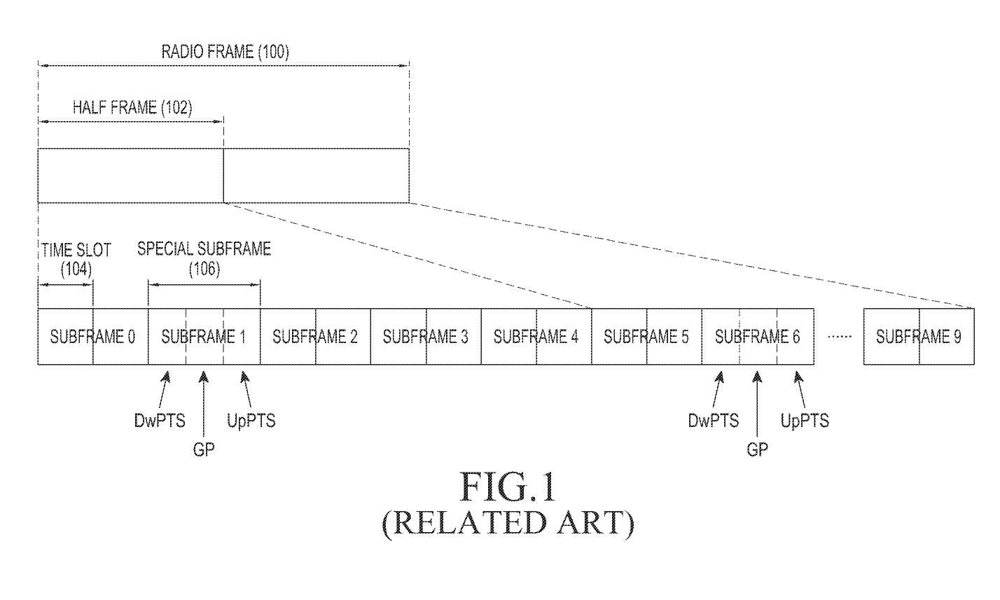

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In order to make the object, technical solution and merits of the present invention more clear, exemplary embodiments the present invention will be illustrated in detail hereinafter with reference to the accompanying drawings and specific exemplary embodiments of the present invention.

According to exemplary embodiments of the present invention, for the uplink and downlink configuration of a traffic adaptation system, the synchronous Hybrid Automatic Repeat Request (HARQ) transmission of Physical Uplink Shared Channel (PUSCH) is implemented according to the timing relationship from the Physical Downlink Control Channel (PDCCH) and Physical Hybrid-ARQ Indicator Channel (PHICH) of a certain uplink and downlink configuration in the Long Term Evolution (LTE) and LTE-Advanced (LTE-A) to the PUSCH and the timing relationship from the PUSCH to the PHICH.

In the traffic adaptation system, the uplink and downlink configuration of a cell dynamically changes with the uplink and downlink traffic of the cell. According to the dynamically changing condition, exemplary embodiments of the present invention provide a method of determining the synchronous HARQ timing relationship of PUSCH. According to exemplary embodiments of the present invention, when scheduling PUSCH resources to the User Equipment (UE) via the PDCCH, a base station transmits the UE reference uplink and downlink configuration for determining the synchronous HARQ timing relationship of PUSCH through the bit value of an Uplink (UL)-Index or a UL-Downlink Assignment Index (UL-DAI) of a UL-Grant in the PDCCH and/or the serial number of a subframe in which the UL-Grant is located. The UE checks a PDCCH with the UL-Grant in all downlink subframes in which the UL-Grant may appears, determines reference uplink and downlink configuration applied by the PUSCH according to the information of UL-index or UL-DAI and/or the location of the UL-Grant, and determines the synchronous HARQ timing relationship applied by the PUSCH according to the reference uplink and downlink configuration. The timing relationship refers to a timing relationship from the PDCCH and PHICH to the PUSCH and a timing relationship from the PUSCH to the PHICH. The reference uplink and downlink configuration is only used for determining the synchronous HARQ timing relationship of the PUSCH, and may not be identical to the arrangement of actual uplink and downlink subframes of a current base station.

The PUSCH transmission method according to exemplary embodiments of the present invention is implemented as shown in FIG. 2.

FIG. 2 is a flowchart of a Physical Uplink Shared Channel (PUSCH) transmission method according to an exemplary embodiment of the present invention.

At step 301, the UE checks the PDCCH in all subframes in which uplink scheduling may occur and obtains the UL-Grant.

In seven types of Time Division Duplexing (TDD) uplink and downlink configurations defined in the LTE and LTE-A according to the related art, a subframe 2 is an uplink subframe in all configurations, and a subframe 7 is not used for transmitting the UL-Grant and PHICH when the subframe 7 is used as a downlink subframe. All subframes in which uplink scheduling may occur are subframes except the subframe 2 and the subframe 7 (e.g., uplink scheduling may occur at subframes #0, #1, #3, #4, #5, #6, #8 and #9).

The UL-Grant is carried by a PDCCH with a Default Check Initialization (DCI) format 0, and the UE recognizes the UL-Grant according to the DCI format.

When transmitting the PDCCH, the base station determines the serial number of the subframe in which the UL-Grant is located according to the reference uplink and downlink configuration to be transmitted to the UE, and/or determines the bit value of the UL-Index or the UL-DAI in the UL-Grant, so as to carry the reference uplink and downlink configuration of the scheduled PUSCH according to the bit value of the UL-Index or the UL-DAI and/or the serial number of the subframe in which the UL-Grant is located. The method of carrying the reference uplink and downlink configuration corresponds to a method of determining the reference uplink and downlink configuration by the UE, and will be described in relation to step 302.

At step 302, the UE determines the reference uplink and downlink configuration of the scheduled PUSCH according to the bit value of UL-Index or UL-DAI and/or the serial number of subframe where the UL-Grant is located, and performs synchronous HARQ transmission of the PUSCH in a corresponding subframe of the cell according to the synchronous HARQ timing relationship of PUSCH of the reference uplink and downlink configuration.

If the UL-Index or the UL-DAI has 2 bits, according to the conversion from a binary system to a decimal system, the 2 bits may indicate four values including 0, 1, 2 and 3, which are hereinafter represented by a, b, c and d. Exemplary embodiments of the present invention do not limit a relationship between a set of {a, b, c, d} and a set of {0, 1, 2, 3}. If the UL-Index or the UL-DAI has more than 2 bits, the above relationship may also be applied, which will not be illustrated in detail.

Several types of relationships between the UL-Grant and the uplink and downlink configuration of PUSCH will be described.

First, according to the timing relationship from the PDCCH to the PUSCH, the number of types of reference uplink and downlink configurations to be transmitted to the UE is analyzed.

As mentioned above, Table 2-1 shows the timing relationship from the PDCCH to the PUSCH. As can be seen from Table 2-1, for the configurations 1-5, the values of k corresponding to the same downlink subframe are the same. For example, for the configurations 1-5, if the PDCCH is detected in a subframe n, the HARQ timing relationship corresponding to the subframe n is the same. Accordingly, in the PDCCH, the configurations 1-5 may be represented uniformly, which corresponds to one type of reference uplink and downlink configurations.

For the configuration 0, as shown in Table 2-1, one or two uplink subframes may be scheduled in one downlink subframe. Based on this, in the LTE and LTE-A, each downlink subframe of the uplink and downlink configuration 0 has three kinds of scheduling. Two kinds of scheduling are scheduling a single Transmission Time Interval (TTI). The scheduling a single TTI refers to scheduling when only one of UL-Index's two bits in the LTE is 1. The other kind of scheduling is scheduling two TTIs for one time, which is called 2-TTI scheduling. In LTE Release 8, the 2-TTI scheduling is scheduling when the UL-Index's two bits are both 1. In the relationship between the UL-Grant and the uplink and downlink configuration of PUSCH, in order to represent the reference uplink and downlink configuration by using a minimal amount of information, for the uplink and downlink configuration 0, one of the three kinds of scheduling is deleted, and the other two kinds of scheduling are retained. The remaining two kinds of scheduling are respectively called the type I of configuration 0 and the type II of configuration 0. As can be seen, the scheduling modes indicated respectively by the type I and the type II are different. According to the deleted scheduling, the scheduling corresponding to the type I and the type II is different, which will be illustrated in detail hereinafter. After one kind of scheduling is deleted, the uplink and downlink configuration 0 corresponds to two different kinds of scheduling, and thus corresponds to two types of timing relationship from the PDCCH to the PUSCH. Accordingly, the remaining two types of scheduling corresponding to the uplink and downlink configuration 0 respectively correspond to one type of reference uplink and downlink configuration.

The configuration 6 corresponds to one type of reference uplink and downlink configuration by itself.

As mentioned above, there are four types of reference uplink and downlink configurations. Because the UL-Index or the UL-DAI has 2 bits, which just correspond to the four types of reference uplink and downlink configurations. Simply, the four values of UL-Index or UL-DAI may correspond to the four types of reference uplink and downlink configurations, and the reference uplink and downlink configurations are transmitted to the UE through the four values of the UL-Index or the UL-DAI; or, the serial number of subframe in which the UL-Grant is located, individually or through combining with the values of the UL-Index or the UL-DAI, corresponds to the four types of reference uplink and downlink configurations. The saved partial values of UL-Index or UL-DAI are also used for the UL-DAI.

Methods for determining the reference uplink and downlink configuration transmitted by the base station are described below.

### (I) A First Implementation Method:

In the first implementation method, for the uplink and downlink configuration 0, the single TTI scheduling is deleted. If the ratio between uplink subframes and downlink subframes is 6:4, the base station needs to perform the deleted single TTI scheduling, and the scheduling of the same downlink subframe index in the uplink and downlink configuration 6 may be applied.

It is predefined that the four bit values of the UL-Index or the UL-DAI respectively correspond to the predefined four types of reference uplink and downlink configurations. After obtaining the UL-Grant, the UE determines, according to the bit values of UL-Index or UL-DAI in the UL-Grant and the predefined relationship between the bit values of UL-Index or UL-DAI and the four types of reference uplink and downlink configurations, the information of the reference uplink and downlink configuration transmitted by the base station.

Specifically, suppose the UE detects the UL-Grant of the UE in the nth subframe in a frame.

First, if the bit value of the UL-Index or UL-DAI is predefined a, the determined reference uplink and downlink configuration is the type I of the configuration 0, which indicates that the PUSCH transmission of the UE applies the uplink and downlink configuration 0, and the PUSCH is transmitted on the (n+k)th subframe, where the value of k is shown in the configuration 0 of Table 3-1.

TABLE 3-1

| serial | | | | | | | | | | |
|---|---|---|---|---|---|---|---|---|---|---|
| number of | downlink subframe index n | | | | | | | | | |
| configuration | 0 | 1 | 2 | 3 | 4 | 5 | 6 | 7 | 8 | 9 |
| 0 | 4 | 6 | | | | 4 | 6 | | | |
| 1 | | 6 | | | 4 | | 6 | | | 4 |
| 2 | | | | 4 | | | | | 4 | |
| 3 | 4 | | | | | | | | 4 | 4 |
| 4 | | | | | | | | | 4 | 4 |
| 5 | | | | | | | | | 4 | |
| 6 | 7 | 7 | | | | 7 | 7 | | | 5 |

Second, if the value of the UL-Index or the UL-DAI bit is predefined c, the determined reference uplink and downlink configuration is the configurations 1-5, which indicates that the PUSCH transmission of the UE applies the uplink and downlink configurations 1-5, and the PUSCH is transmitted in the (n+k)^{th} subframe, where the value of k is shown in the configurations 1-5 of Table 3-1. For example, when a downlink subframe index is n, k is a value in any non-null item corresponding to the configurations 1-5 in Table 3-1. For example, when the downlink subframe index n=2, only the configuration 1 is a non-null item, the value corresponding to the non-null item is 6, and thus when n=2, if the PUSCH applies the configurations 1-5, then k=6.

The time sequence of the configurations 1-5 in Table 3-1 is arranged in a row (e.g., as illustrated in Table 3-1-1). If the PUSCH of the UE applies the uplink and downlink configurations 1-5, for the PDCCH received in the n^{th} subframe, the PUSCH is transmitted in the (n+k)^{th} subframe, where the value of k is shown in the configurations 1-5 of Table 3-1-1.

TABLE 3-1-1

| serial | | | | | | | | | | |
|---|---|---|---|---|---|---|---|---|---|---|
| number of | downlink subframe index n | | | | | | | | | |
| configuration | 0 | 1 | 2 | 3 | 4 | 5 | 6 | 7 | 8 | 9 |
| 0 | 4 | 6 | | | | 4 | 6 | | | |
| 1-5 | 4 | 6 | | 4 | 4 | | 6 | | 4 | 4 |
| 6 | 7 | 7 | | | | 7 | 7 | | | 5 |

Third, if the bit value of the UL-Index or the UL-DAI is predefined d, the determined reference uplink and downlink configuration is the configuration 6, which indicates that the PUSCH transmission of the UE applies the uplink and downlink configuration 6, and the PUSCH is transmitted in the (n+k)^{th} subframe, where the value of k is shown in the configuration 6 of Table 3-1.

Fourth, if the bit value of the UL-Index or the UL-DAI is predefined b, the determined reference uplink and downlink configuration is the type II of the configuration 0, which indicates that the PUSCH transmission of the UE applies the uplink and downlink configuration 0, and the PUSCH is transmitted in the (n+k)^{th} subframe and the (n+7)^{th} subframe, where the value of k is shown in the configuration 0 of Table 3-1

The above implementation method may be replaced with another method, as shown in Table 3-2. Suppose the UE detects the UL-Grant of the UE in the n^{th} subframe, and transmits the PUSCH in the (n+k)^{th} subframe. In Table 3-2, there are two sections in an item corresponding to each subframe and configuration n, one is numerals outside parentheses, and the other one is numerals inside parentheses. The numerals outside parentheses correspond to the value of k, and the numerals corresponding to a code x inside parentheses represents the code words used by the UL-Index or the UL-DAI.

TABLE 3-2

| serial | | | | | | | | | | |
|---|---|---|---|---|---|---|---|---|---|---|
| number of | downlink subframe index n | | | | | | | | | |
| configuration | 0 | 1 | 2 | 3 | 4 | 5 | 6 | 7 | 8 | 9 |
| 0 | 4 (code a), | 6 (code a), | | | | 4 (code a), | 6 (code a), | | | |
| | or | or | | | | or | or | | | |
| | 4&7 (code b) | 6&7 (code b) | | | | 4&7 (code b | 6&7 (code b) | | | |
| 1 | | 6 (code c) | | | 4 (code c) | | 6 (code c) | | | 4 (code c) |
| 2 | | | | 4 (code c) | | | | | 4 (code c) | |
| 3 | 4 (code c) | | | | | | | | 4 (code c) | 4 (code c) |
| 4 | | | | | | | | | 4 (code c) | 4 (code c) |
| 5 | | | | | | | | | 4 (code c) | |
| 6 | 7 (code d) | 7 (code d) | | | | 7 (code d) | 7 (code d) | | | 5 (code d) |

The time sequence of the configurations 1-5 in Table 3-2 is arranged in a row, as shown in Table 3-2-1.

TABLE 3-2-1

| serial | | | | | | | | | | |
|---|---|---|---|---|---|---|---|---|---|---|
| number of | downlink subframe index n | | | | | | | | | |
| configuration | 0 | 1 | 2 | 3 | 4 | 5 | 6 | 7 | 8 | 9 |
| 0 | 4 (code a), | 6 (code a), | | | | 4 (code a), | 6 (code a), | | | |
| | or | or | | | | or | or | | | |
| | 4&7 (code b) | 6&7 (code b) | | | | 4&7 (code b | 6&7 (code b) | | | |
| 1-5 | 4 (code c) | 6 (code c) | | 4 (code c) | 4 (code c) | | 6 (code c) | | 4 (code c) | 4 (code c) |
| 6 | 7 (code d) | 7 (code d) | | | | 7 (code d) | 7 (code d) | | | 5 (code d) |

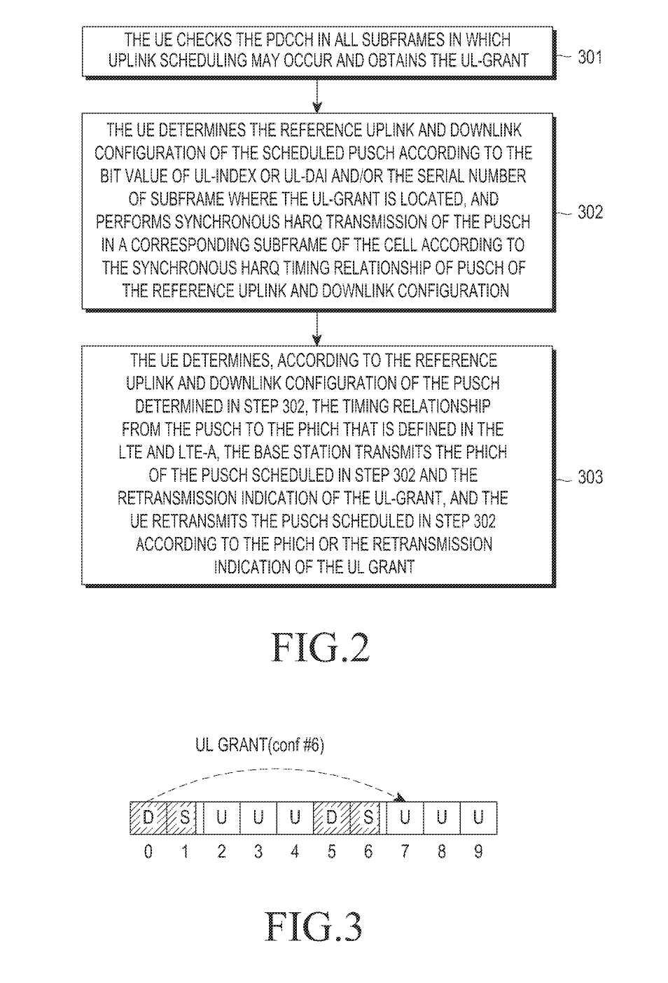

FIG. 3 is a schematic diagram illustrating a timing relationship of PUSCH scheduling that is determined according to a bit value of an Uplink (UL)-Index or a UL-DAI in a UL-Grant according to an exemplary embodiment of the present invention.

Referring to FIG. 3, in the 0^{th} subframe, the UE detects the UL-Grant, and detects that the UL-Index or UL-DAI in the UL-Grant is d. And thus, the UE applies the time sequence of the configuration 6, and schedules the PUSCH in (0+7)^{th} subframe according to Table 3-2 or 3-1.

As can be seen, the deleted single TTI scheduling of the configuration 0 in this method is the scheduling of the (n+7)^{th} subframe. Other single TTI scheduling of the configuration 0 may be deleted.

As mentioned above, the base station implements the deleted scheduling in configuration 0 through the same downlink subframes of the configuration 6. If the scheduling of the (n+4)^{th} subframe is deleted, when n=5, what corresponds to the (n+4=9)^{th} subframe in the configuration 6 is a downlink subframe instead of an uplink subframe. In this case, it is impossible to implement the scheduling of the (n+4)^{th} subframe in the configuration 0 through the same downlink subframes of the configuration 6. Based on this, preferably, exemplary embodiments of the present invention provide another method of deleting the single TTI scheduling of the configuration 0. The method includes, when n=0 or 5, deleting the scheduling of the (n+7)^{th} subframe, and retaining the scheduling of the (n+4)^{th} subframe and 2-TTI scheduling; when n=1 or 6, deleting the scheduling of the (n+6)^{th} subframe, and retaining the scheduling of the (n+7)^{th} subframe and the 2-TTI scheduling. Based on the deleting of the single TTI scheduling of the configuration 0, an alternative method of the above first implementation method may be obtained.

### A First Alternative Method of the First Implementation Method

First, if the bit value of the UL-Index or the UL-DAI is predefined a, the determined reference uplink and downlink configuration is the type I of the configuration 0, which indicates that the PUSCH transmission of the UE applies the uplink and downlink configuration 0, and the PUSCH is transmitted in the (n+k)^{th} subframe, where the value of k is shown in the configuration 0 of Table 4-1.

TABLE 4-1

| serial | | | | | | | | | | |
|---|---|---|---|---|---|---|---|---|---|---|
| number of | downlink subframe index n | | | | | | | | | |
| configuration | 0 | 1 | 2 | 3 | 4 | 5 | 6 | 7 | 8 | 9 |
| 0 | 4 | 7 | | | | 4 | 7 | | | |
| 1 | | 6 | | | 4 | | 6 | | | 4 |
| 2 | | | | 4 | | | | | 4 | |
| 3 | 4 | | | | | | | | 4 | 4 |
| 4 | | | | | | | | | 4 | 4 |
| 5 | | | | | | | | | 4 | |
| 6 | 7 | 7 | | | | 7 | 7 | | | 5 |

Second, if the bit value of the UL-Index or the UL-DAI is predefined c, the determined reference uplink and downlink configuration is the configurations 1-5, which indicates that the PUSCH transmission of the UE applies the uplink and downlink configurations 1-5, and the PUSCH is transmitted on the (n+k)^{th} subframe, where the value of k is shown in the configurations 1-5 of Table 4-1. For example, when the downlink subframe index is n, k is a value in any non-null item according to the configurations 1-5 in Table 4-1.

The time sequence of the configurations 1-5 in Table 4-1 is arranged in a row (e.g., as illustrated in Table 4-1-1). If the PUSCH of the UE applies the uplink and downlink configurations 1-5, for the PDCCH received in the n^{th} subframe, the PUSCH is transmitted in the (n+k)^{th} subframe, where the value of k is shown in the configurations 1-5 of Table 4-1-1.

TABLE 4-1-1

| serial | | | | | | | | | | |
|---|---|---|---|---|---|---|---|---|---|---|
| number of | downlink subframe index n | | | | | | | | | |
| configuration | 0 | 1 | 2 | 3 | 4 | 5 | 6 | 7 | 8 | 9 |
| 0 | 4 | 7 | | | | 4 | 7 | | | |
| 1-5 | 4 | 6 | | 4 | 4 | | 6 | | 4 | 4 |
| 6 | 7 | 7 | | | | 7 | 7 | | | 5 |

Third, if the bit value of the UL-Index or the UL-DAI is predefined d, the determined reference uplink and downlink configuration is the configuration 6, which indicates that the PUSCH transmission of the UE applies the uplink and downlink configuration 6, and the PUSCH is transmitted in the (n+k)^{th} subframe, where the value of k is shown in the configuration 6 of Table 4-1.

Fourth, if the bit value of the UL-Index or the UL-DAI is predefined b, the determined reference uplink and downlink configuration is the type II of the configuration 0, which indicates that the PUSCH transmission of the UE applies the uplink and downlink configuration 0. If n=0 and n=5, the PUSCH is transmitted in the (n+k)^{th} subframe and the (n+7)^{th} subframe; if n=1 and n=6, the PUSCH is transmitted in the (n+k)^{th} subframe and the (n+6)^{th} subframe, where the value of k is shown in the configuration 0 of Table 4-1.

The above implementation method may be replaced with another method, as shown in Table 4-2.

TABLE 4-2

| serial | | | | | | | | | | |
|---|---|---|---|---|---|---|---|---|---|---|
| number of | downlink subframe index n | | | | | | | | | |
| configuration | 0 | 1 | 2 | 3 | 4 | 5 | 6 | 7 | 8 | 9 |
| 0 | 4 (code a), | 7 (code a), | | | | 4 (code a), | 7 (code a), | | | |
| | or | or | | | | or | or | | | |
| | 4&7 (code b) | 6&7 (code b) | | | | 4&7 (code b | 6&7 (code b) | | | |
| 1 | | 6 (code c) | | | 4 (code c) | | 6 (code c) | | | 4 (code c) |
| 2 | | | | 4 (code c) | | | | | 4 (code c) | |
| 3 | 4 (code c) | | | | | | | | 4 (code c) | 4 (code c) |
| 4 | | | | | | | | | 4 (code c) | 4 (code c) |
| 5 | | | | | | | | | 4 (code c) | |
| 6 | 7 (code d) | 7 (code d) | | | | 7 (code d) | 7 (code d) | | | 5 (code d) |

The time sequence of the configurations 1-5 in Table 4-2 may be arranged in a row, as shown in Table 4-2-1.

TABLE 4-2-1

| serial | | | | | | | | | | |
|---|---|---|---|---|---|---|---|---|---|---|
| number of | downlink subframe index n | | | | | | | | | |
| configuration | 0 | 1 | 2 | 3 | 4 | 5 | 6 | 7 | 8 | 9 |
| 0 | 4 (code a), | 7 (code a), | | | | 4 (code a), | 7 (code a), | | | |
| | or | or | | | | or | or | | | |
| | 4&7 (code b) | 6&7 (code b) | | | | 4&7 (code b | 6&7 (code b) | | | |
| 1-5 | 4 (code c) | 6 (code c) | | 4 (code c) | 4 (code c) | | 6 (code c) | | 4 (code c) | 4 (code c) |
| 6 | 7 (code d) | 7 (code d) | | | | 7 (code d) | 7 (code d) | | | 5 (code d) |

In the above first implementation method and the first alternative method, the bit value of the UL-Index or UL-DAI is used for representing four types of reference uplink and downlink configurations, which is unrelated to the location of the subframe in which the UL-Grant is located.

Exemplary embodiments of the present invention may also determine the reference uplink and downlink configuration through the serial number of the subframe where the UL-Grant is located.

First, the relationship between the serial number of the subframe in which the UL-Grant is located and different uplink and downlink configurations is analyzed.

As can be seen from Table 2-1, in the downlink subframe 0, 1, 5 or 6, four types of reference uplink and downlink configurations may appear. In the downlink subframe 3, 4 or 8, only the second type of reference uplink and downlink configuration appears (e.g., the configurations 1-5). For example, the subframe 3, 4 or 8 is a downlink subframe unless the configurations 1-5 appear. In the downlink subframe 9, only the second and third types of reference uplink and downlink configurations appear.

According to the above analysis, if the UL-Grant is located in the subframe 0, 1, 5 or 6, the four bit values of the UL-Index or the UL-DAI respectively need to be used for representing the four types of reference uplink and downlink configurations which may appear. If the UL-Grant is located in the subframe 3, 4 or 8, the reference uplink and downlink configuration is the configurations 1-5. The bit of the UL-Index or UL-DAI may be used for carrying other information, for example, still functions as the UL-DAI in the LTE and LTE-A. If the UL-Grant is located in the subframe 9, a predefined bit value of the UL-Index or the UL-DAI may be used for representing the configuration 6. When the bit value of the UL-Index or the UL-DAI is not predefined, the bit value of the UL-Index or UL-DAI represents the configurations 1-5. Other bit values of the UL-Index or UL-DAI except the predefined bit value may be used for representing other information (e.g., function as a new UL-DAI).

An implementation mode of the UL-Index or UL-DAI in the subframe 9 is called a new UL-DAI. The implementation mode of new UL-DAI is as shown in Table 5-0.

TABLE 5-0

| | uplink and downlink | |
|---|---|---|
| UL-DAI | configuration | V_{DAI}^{UL} |
| 0 | 1-5 | 1 |
| 1 | 1-5 | 2 or 3 |
| 2 | 1-5 | 4 |
| 3 | 6 | / |

V_{DAI}^{UL} is defined in the LTE and LTE-A, and is used for indicating the number of PDSCH transmission subframes to be returned by the subframe in which the scheduled PUSCH is located. The implementation mode of new UL-DAI may be implemented through Tables 5-0-1, 5-0-2 or 5-0-3.

TABLE 5-0-1

| UL-DAI | uplink and downlink configuration | V_{DAI}^{UL} |
|---|---|---|
| 0 | 1-5 | 1 or 4 |
| 1 | 1-5 | 2 |
| 2 | 1-5 | 3 |
| 3 | 6 | / |

TABLE 5-0-2

| UL-DAI | uplink and downlink configuration | V_{DAI}^{UL} |
|---|---|---|
| 0 | 1-5 | 1 or 2 |
| 1 | 1-5 | 3 |
| 2 | 1-5 | 4 |
| 3 | 6 | / |

TABLE 5-0-3

| UL-DAI | uplink and downlink configuration | V_{DAI}^{UL} |
|---|---|---|
| 0 | 1-5 | 1 |
| 1 | 1-5 | 2 |
| 2 | 1-5 | 3 or 4 |
| 3 | 6 | / |

When the reference uplink and downlink configuration is carried through the above mode, the following two implementation methods may be obtained through combining the above first implementation method and the first alternative method, which are respectively called alternative methods 2-1 and 2-2 of the first implementation method.

### An Alternative Method 2-1 of the First Implementation Method:

First, if the detected UL-Grant is located in the 0^{th}, 1^{st}, 5^{th}, and 6^{th} subframes of each frame, the bit value of the UL-Index or UL-DAI is checked. If the bit value of the UL-Index or UL-DAI is a, the PUSCH of the UE applies the uplink and downlink configuration 0, and the PUSCH is transmitted in the (n subframe, where the value of k is shown in the configuration 0 of Table 5-1.

TABLE 5-1

| serial | | | | | | | | | | |
|---|---|---|---|---|---|---|---|---|---|---|
| number of | downlink subframe index n | | | | | | | | | |
| configuration | 0 | 1 | 2 | 3 | 4 | 5 | 6 | 7 | 8 | 9 |
| 0 | 4 | 6 | | | | 4 | 6 | | | |
| 1 | | 6 | | | 4 | | 6 | | | 4 |
| 2 | | | | 4 | | | | | 4 | |
| 3 | 4 | | | | | | | | 4 | 4 |
| 4 | | | | | | | | | 4 | 4 |
| 5 | | | | | | | | | 4 | |
| 6 | 7 | 7 | | | | 7 | 7 | | | 5 |

If the bit value of the UL-Index or UL-DAI is c, the PUSCH of the UE applies the uplink and downlink configurations 1-5, and the PUSCH is transmitted in the (n+k)^{th} subframe, where the value of k is shown in the configurations 1-5 of Table 5-1. For example, when the downlink subframe index is n, k is a value in any non-null item corresponding to the configurations 1-5 of Table 5-1. If the bit value of the UL-Index or UL-DAI is d, the PUSCH of the UE applies the uplink and downlink configuration 6, and the PUSCH is transmitted in the (n+k)^{th} subframe, where the value of k is shown in the configuration 6 of Table 5-1. If the bit value of the UL-Index or UL-DAI is b, the PUSCH of the UE applies the uplink and downlink configuration 0, and the PUSCH is transmitted in the (n+k)^{th} subframe and the (n+7)^{th} subframe, where the value of k is shown in the configuration 0 of Table 5-1.

Second, if the detected UL-Grant is located in the 3^{rd}, 4^{th} and 8^{th} subframes of each frame, the PUSCH of the UE applies the uplink and downlink configurations 1-5, and the PUSCH is transmitted in the (n+k)^{th} subframe, where the value of k is shown in the configurations 1-5 of Table 5-1. For example, when the downlink subframe index is n, k is a value in any non-null item corresponding to the configurations 1-5 of Table 5-1, and the bit value of the UL-Index or UL-DAI is still explained according to the “UL-DAI” in the LTE and LTE-A.

Third, if the detected UL-Grant is located in the 9^{th} subframe of each frame, and the bit value of the UL-Index or UL-DAI is d, the PUSCH of the UE applies the uplink and downlink configuration 6, and the PUSCH is transmitted in the (n+k)^{th} subframe, where the value of k is shown in the configuration 6 of Table 5-1. If the bit value of the UL-Index or UL-DAI is not d, the PUSCH of the UE applies the uplink and downlink configurations 1-5, and the PUSCH is transmitted in the (n+k)^{th} subframe, where the value of k is shown in the configurations 1-5 of Table 5-1. For example, when the downlink subframe index is n, k is a value in any non-null item corresponding to the configurations 1-5 of Table 5-1, and the bit value of the UL-Index or UL-DAI is still explained according to the new UL-DAI defined in Table 5-0, Table 5-0-1, Table 5-0-2 or Table 5-0-3.

The time sequence of the configurations 1-5 in Table 5-1 is arranged in a row, which has the same representation as that shown in Table 3-1-1.

The above implementation method may be replaced with another mode, as shown in Table 5-2.

TABLE 5-2

| serial | | | | | | | | | | |
|---|---|---|---|---|---|---|---|---|---|---|
| number of | downlink subframe index n | | | | | | | | | |
| configuration | 0 | 1 | 2 | 3 | 4 | 5 | 6 | 7 | 8 | 9 |
| 0 | 4 (code a), | 6 (code a), | | | | 4 (code a), | 6 (code a), | | | |
| | or | or | | | | or | or | | | |
| | 4&7 (code b) | 6&7 (code b) | | | | 4&7 (code b | 6&7 (code b) | | | |
| 1 | | 6 (code c) | | | 4 (UL- | | 6 (code c) | | | 4 (new |
| | | | | | DAI) | | | | | UL-DAI) |
| 2 | | | | 4 (UL- | | | | | 4 (UL- | |
| | | | | DAI) | | | | | DAI) | |
| 3 | 4 (code c) | | | | | | | | 4 (UL- | 4 (new |
| | | | | | | | | | DAI) | UL-DAI) |
| 4 | | | | | | | | | 4 (UL- | 4 (new |
| | | | | | | | | | DAI) | UL-DAI) |
| 5 | | | | | | | | | 4 (UL- | |
| | | | | | | | | | DAI) | |
| 6 | 7 (code d) | 7 (code d) | | | | 7 (code d) | 7 (code d) | | | 5 (code d) |

The “UL-DAI” inside parentheses in Table 5-2 indicates that the code words of the UL-DAI function as the UL-DAI in the LTE and LTE-A. The “new UL-DAI” inside parentheses indicates that the code words of the UL-DAI function as the “new UL-DAI” defined in Table 5-0, Table 5-0-1, Table 5-0-2 or Table 5-0-3.

The time sequence of the configurations 1-5 in Table 5-2 is arranged in a row, as shown in Table 5-2-1.

TABLE 5-2-1

| serial | | | | | | | | | | |
|---|---|---|---|---|---|---|---|---|---|---|
| number of | downlink subframe index n | | | | | | | | | |
| configuration | 0 | 1 | 2 | 3 | 4 | 5 | 6 | 7 | 8 | 9 |
| 0 | 4 (code a), | 6 (code a), | | | | 4 (code a), | 6 (code a), | | | |
| | or | or | | | | or | or | | | |
| | 4&7 (code b) | 6&7 (code b) | | | | 4&7 (code b) | 6&7 (code b) | | | |
| 1-5 | 4 (code c) | 6 (code c) | | 4 (UL- | 4 (UL- | | 6 (code c) | | 4 (UL-DAI) | 4 (new |
| | | | | DAI) | DAI) | | | | | UL-DAI) |
| 6 | 7 (code d) | 7 (code d) | | | | 7 (code d) | 7 (code d) | | | 5 (code d) |

### An Alternative Method 2-2 of the First Implementation Method:

First, if the detected UL-Grant is located in the 0^{th}, 1^{st}, 5^{th} and 6^{th} subframes of each frame, the bit value of the UL-Index or UL-DAI is checked. If the bit value of the UL-Index or UL-DAI is a, the PUSCH of the UE applies the uplink and downlink configuration 0, and the PUSCH is transmitted in the (n+k)^{th} subframe, where the value of k is shown in the configuration 0 of Table 6-1.

TABLE 6-1

| serial | | | | | | | | | | |
|---|---|---|---|---|---|---|---|---|---|---|
| number of | downlink subframe index n | | | | | | | | | |
| configuration | 0 | 1 | 2 | 3 | 4 | 5 | 6 | 7 | 8 | 9 |
| 0 | 4 | 7 | | | | 4 | 7 | | | |
| 1 | | 6 | | | 4 | | 6 | | | 4 |
| 2 | | | | 4 | | | | | 4 | |
| 3 | 4 | | | | | | | | 4 | 4 |
| 4 | | | | | | | | | 4 | 4 |
| 5 | | | | | | | | | 4 | |
| 6 | 7 | 7 | | | | 7 | 7 | | | 5 |

If the bit value of the UL-Index or UL-DAI is c, the PUSCH of the UE applies the uplink and downlink configurations 1-5, and the PUSCH is transmitted in the (n+k)^{th} subframe, where the value of k is shown in the configurations 1-5 of Table 6-1. For example, when the downlink subframe index is n, k is a value in any non-null item corresponding to the configurations 1-5 of Table 6-1. If the bit value of the UL-Index or UL-DAI is d, the PUSCH of the UE applies the uplink and downlink configuration 6, and the PUSCH is transmitted in the (n+k)^{th} subframe, where the value of k is shown in the configuration 6 of Table 6-1. If the bit value of the UL-Index or UL-DAI is b, the PUSCH of the UE applies the uplink and downlink configuration 0. If n=0 and n=5, the PUSCH is transmitted in the (n+k)^{th} subframe and the (n+7)^{th} subframe, and if n=1 and n=6, the PUSCH is transmitted in the (n+k)^{th} subframe and the (n+7)^{th} subframe, where the value of k is shown in the configuration 0 of Table 6-1.

Second, if the detected UL-Grant is located in the 3^{rd}, 4^{th} and 8^{th} subframes of each frame, the PUSCH of the UE applies the uplink and downlink configurations 1-5, and the PUSCH is transmitted in the (n+k)^{th} subframe, where the value of k is shown in the configurations 1-5 of Table 6-1. For example, when the downlink subframe index is n, k is a value in any non-null item corresponding to the configurations 1-5 of Table 6-1, and the bit value of the UL-Index or UL-DAI is still explained according to the “UL-DAI” in the LTE and LTE-A.

Third, if the detected UL-Grant is located in the 9^{th} subframe of each frame, and the bit value of the UL-Index or UL-DAI is d, then the PUSCH of the UE applies the uplink and downlink configuration 6, and the PUSCH is transmitted in the (n+k)^{th} subframe, where the value of k is shown in the configuration 6 of Table 6-1. If the bit value of the UL-Index or UL-DAI is not d, then the PUSCH of the UE applies the uplink and downlink configurations 1-5, and the PUSCH is transmitted in the (n+k)^{th} subframe, where the value of k is shown in the configurations 1-5 of Table 6-1. For example, when the downlink subframe index is n, k is a value in any non-null item corresponding to the configurations 1-5 of Table 6-1, and the bit value of the UL-Index or UL-DAI is explained according to the “new UL-DAI” defined in Table 5-0, Table 5-0-1, Table 5-0-2 or Table 5-0-3.

The time sequence of the configuration 1-5 in Table 6-1 is arranged in a row, which has the same representation as that shown in Table 4-1-1. The above implementation method may be replaced with another mode, as shown in Table 6-2.

TABLE 6-2

| serial | | | | | | | | | | |
|---|---|---|---|---|---|---|---|---|---|---|
| number of | downlink subframe index n | | | | | | | | | |
| configuration | 0 | 1 | 2 | 3 | 4 | 5 | 6 | 7 | 8 | 9 |
| 0 | 4 (code a), | 7 (code a), | | | | 4 (code a), | 7 (code a), | | | |
| | or | or | | | | or | or | | | |
| | 4&7 (code b) | 6&7 (code b) | | | | 4&7 (code b | 6&7 (code b) | | | |
| 1 | | 6 (code c) | | | 4 (UL- | | 6 (code c) | | | 4 (new |
| | | | | | DAI) | | | | | UL-DAI) |
| 2 | | | | 4 (UL- | | | | | 4 (UL- | |
| | | | | DAI) | | | | | DAI) | |
| 3 | 4 (code c) | | | | | | | | 4 (UL- | 4 (new |
| | | | | | | | | | DAI) | UL-DAI) |
| 4 | | | | | | | | | 4 (UL- | 4 (new |
| | | | | | | | | | DAI) | UL-DAI) |
| 5 | | | | | | | | | 4 (UL- | |
| | | | | | | | | | DAI) | |
| 6 | 7 (code d) | 7 (code d) | | | | 7 (code d) | 7 (code d) | | | 5 (code d) |

The “UL-DAI” inside parentheses in Table 6-2 indicates that the code words of the UL-DAI function as the UL-DAI in the LTE and LTE-A. The “new UL-DAI” inside parentheses indicates that the code words of UL-DAI function as “new UL-DAI” defined in Table 5-0, Table 5-0-1, Table 5-0-2 or Table 5-0-3.

The time sequence of the configuration 1-5 in Table 6-2 is arranged in a row, as shown in Table 6-2-1.

TABLE 6-2-1

| serial | | | | | | | | | | |
|---|---|---|---|---|---|---|---|---|---|---|
| number of | downlink subframe index n | | | | | | | | | |
| configuration | 0 | 1 | 2 | 3 | 4 | 5 | 6 | 7 | 8 | 9 |
| 0 | 4 (code a), | 7 (code a), | | | | 4 (code a), | 7 (code a), | | | |
| | or | or | | | | or | or | | | |
| | 4&7 (code b) | 6&7 (code b) | | | | 4&7 (code b | 6&7 (code b) | | | |
| 1-5 | 4 (code c) | 6 (code c) | | 4 (UL- | 4 (UL- | | 6 (code c) | | 4 (UL- | 4 (new |
| | | | | DAI) | DAI) | | | | DAI) | UL-DAI) |
| 6 | 7 (code d) | 7 (code d) | | | | 7 (code d) | 7 (code d) | | | 5 (code d) |

### (II) A Second Implementation Method

A difference between this implementation method and the above first implementation method is that for the uplink and downlink configuration 0, the 2-TTI scheduling is deleted, and the other kinds of scheduling are retained. The method of determining the reference uplink and downlink configuration in this implementation method is the same as that in the first implementation method. Suppose the UE detects the UL-Grant of the UE in the n^{th} subframe.

First, if the bit value of the UL-Index or UL-DAI is a, then the PUSCH of the UE applies the uplink and downlink configuration 0, and the PUSCH is transmitted in the (n+k)^{th} subframe, where the value of k is shown in the configuration 0 of Table 7-1. The UL-Grant is carried through the PDCCH with the DCI format 0.

TABLE 7-1

| serial | | | | | | | | | | |
|---|---|---|---|---|---|---|---|---|---|---|
| number of | downlink subframe index n | | | | | | | | | |
| configuration | 0 | 1 | 2 | 3 | 4 | 5 | 6 | 7 | 8 | 9 |
| 0 | 4 | 6 | | | | 4 | 6 | | | |
| 1 | | 6 | | | 4 | | 6 | | | 4 |
| 2 | | | | 4 | | | | | 4 | |
| 3 | 4 | | | | | | | | 4 | 4 |
| 4 | | | | | | | | | 4 | 4 |
| 5 | | | | | | | | | 4 | |
| 6 | 7 | 7 | | | | 7 | 7 | | | 5 |

Second, if the bit value of the UL-Index or UL-DAI is d, the PUSCH of the UE applies the uplink and downlink configuration 6, and the PUSCH is transmitted in the (n+k)^{th} subframe, where the value of k is shown in the configuration 6 of Table 7-1.

Third, if the bit value of UL-Index or UL-DAI is b, the PUSCH of the UE applies the uplink and downlink configuration 0, and the PUSCH is transmitted in the (n+k)^{th} subframe.

Fourth, if the bit value of UL-Index or UL-DAI is b, the PUSCH of the UE applies the uplink and downlink configuration 0, and the PUSCH is transmitted in the (n+k)th subframe.

The time sequence of the configuration 1-5 in Table 7-1 is arranged in a row, which has the same representation as that shown in Table 3-1-1.

The above implementation method may be replaced with another mode, as shown in Table 7-2. In Table 7-2, there are two sections in an item corresponding to each subframe and configuration n, one is numerals outside parentheses, and the other one is numerals inside parentheses. The numerals outside parentheses correspond to the value of k, and code x inside parentheses represents the code words used by the UL-Index or UL-DAI.

TABLE 7-2

| serial | | | | | | | | | | |
|---|---|---|---|---|---|---|---|---|---|---|
| number of | downlink subframe index n | | | | | | | | | |
| configuration | 0 | 1 | 2 | 3 | 4 | 5 | 6 | 7 | 8 | 9 |
| 0 | 4 (code a), | 6 (code a), | | | | 4 (code a), | 6 (code a), | | | |
| | or | or | | | | or | or | | | |
| | 7 (code b) | 7 (code b) | | | | 7 (code b | 7 (code b) | | | |
| 1 | | 6 (code c) | | | 4 (code c) | | 6 (code c) | | | 4 (code c) |
| 2 | | | | 4 (code c) | | | | | 4 (code c) | |
| 3 | 4 (code c) | | | | | | | | 4 (code c) | 4 (code c) |
| 4 | | | | | | | | | 4 (code c) | 4 (code c) |
| 5 | | | | | | | | | 4 (code c) | |
| 6 | 7 (code d) | 7 (code d) | | | | 7 (code d) | 7 (code d) | | | 5 (code d) |

The time sequence of the configurations 1-5 in Table 7-2 is arranged in a row, as shown in Table 7-2-1.

TABLE 7-2-1

| serial | | | | | | | | | | |
|---|---|---|---|---|---|---|---|---|---|---|
| number of | downlink subframe index n | | | | | | | | | |
| configuration | 0 | 1 | 2 | 3 | 4 | 5 | 6 | 7 | 8 | 9 |
| 0 | 4 (code a), | 6 (code a), | | | | 4 (code a), | 6 (code a), | | | |
| | or | or | | | | or | or | | | |
| | 7 (code b) | 7 (code b) | | | | 7 (code b | 7 (code b) | | | |
| 1 | 4 (code c) | 6 (code c) | | 4 (code c) | 4 (code c) | | 6 (code c) | | 4 (code c) | 4 (code c) |
| 6 | 7 (code d) | 7 (code d) | | | | 7 (code d) | 7 (code d) | | | 5 (code d) |

Similar to the first implementation method, according to the different location of subframe, the UL-Index or UL-DAI may be explained respectively. Combining with the alternative methods 2-1 and 2-2 of the first implementation method, a following implementation method may be obtained.

An alternative Method 1 of the Second Implementation Method:

First, if the detected UL-Grant is located in the 0^{th}, 1^{st}, 5^{th} and 6^{th} subframes of each frame, the bit value of the UL-Index or UL-DAI is checked. If the bit value of the UL-Index or UL-DAI is a, then the PUSCH of the UE applies the uplink and downlink configuration 0, and the PUSCH is transmitted in the (n+k)^{th} subframe, where the value of k is shown in the configuration 0 of Table 8-1.

TABLE 8-1

| serial | | | | | | | | | | |
|---|---|---|---|---|---|---|---|---|---|---|
| number of | downlink subframe index n | | | | | | | | | |
| configuration | 0 | 1 | 2 | 3 | 4 | 5 | 6 | 7 | 8 | 9 |
| 0 | 4 | 6 | | | | 4 | 6 | | | |
| 1 | | 6 | | | 4 | | 6 | | | 4 |
| 2 | | | | 4 | | | | | 4 | |
| 3 | 4 | | | | | | | | 4 | 4 |
| 4 | | | | | | | | | 4 | 4 |
| 5 | | | | | | | | | 4 | |
| 6 | 7 | 7 | | | | 7 | 7 | | | 5 |

If the bit value of the UL-Index or UL-DAI is c, then the PUSCH of the UE applies the uplink and downlink configurations 1-5, and the PUSCH is transmitted in the (n+k)^{th} subframe, where the value of k is shown in the configurations 1-5 of Table 8-1. For example, when the downlink subframe index is n, k is a value in any non-null item corresponding to the configurations 1-5 of Table 8-1. If the bit value of the UL-Index or UL-DAI is d, the PUSCH of the UE applies the uplink and downlink configuration 6, and the PUSCH is transmitted in the (n+k)^{th} subframe, where the value of k is shown in the configuration 6 of Table 8-1. If the bit value of the UL-Index or UL-DAI is b, the PUSCH of the UE applies the uplink and downlink configuration 0, and the PUSCH is transmitted in the (n+7)^{th} subframe.

Second, if the detected UL-Grant is located in the 3^{rd}, 4^{th} and 8^{th} subframes of each frame, then the PUSCH of the UE applies the uplink and downlink configurations 1-5, and the PUSCH is transmitted in the (n+k)^{th} subframe, where the value of k is shown in the configurations 1˜5 of Table 8-1. For example, when the downlink subframe index is n, k is a value in any non-null item corresponding to the configurations 1-5 of Table 8-1, and the bit value of the UL-Index or UL-DAI is still explained according to the “UL-DAI” in the LTE and LTE-A.

Third, if the detected UL-Grant is located in the 9^{th} subframe of each frame, and the bit value of the UL-Index or UL-DAI is d, then the PUSCH of the UE applies the uplink and downlink configuration 6, and the PUSCH is transmitted in the (n+k)^{th} subframe, where the value of k is shown in the configuration 6 of Table 8-1. If the bit value of the UL-Index or UL-DAI is not d, the PUSCH of the UE applies the uplink and downlink configurations 1-5, and the PUSCH is transmitted in the (n+k)^{th} subframe, where the value of k is shown in the configurations 1-5 of Table 8-1. For example, when the downlink subframe index is n, k is a value in any non-null item corresponding to the configurations 1-5 of Table 8-1, and the bit value of the UL-Index or UL-DAI is still explained according to the “new UL-DAI” defined in Table 5-0, Table 5-0-1, Table 5-0-2, or Table 5-0-3.

The above implementation method may be replaced with another mode, as shown in Table 8-2.

TABLE 8-2

| serial | | | | | | | | | | |
|---|---|---|---|---|---|---|---|---|---|---|
| number of | downlink subframe index n | | | | | | | | | |
| configuration | 0 | 1 | 2 | 3 | 4 | 5 | 6 | 7 | 8 | 9 |
| 0 | 4 (code a), | 6 (code a), | | | | 4 (code a), | 6 (code a), | | | |
| | or | or | | | | or | or | | | |
| | 7 (code b) | 7 (code b) | | | | 7 (code b | 7 (code b) | | | |
| 1 | | 6 (code c) | | | 4 (UL- | | 6 (code c) | | | 4 (new UL- |
| | | | | | DAI) | | | | | DAI) |
| 2 | | | | 4 (UL- | | | | | 4 (UL- | |
| | | | | DAI) | | | | | DAI) | |
| 3 | 4 (code c) | | | | | | | | 4 (UL- | 4 (new UL- |
| | | | | | | | | | DAI) | DAI) |
| 4 | | | | | | | | | 4 (UL- | 4 (new UL- |
| | | | | | | | | | DAI) | DAI) |
| 5 | | | | | | | | | 4 (UL- | |
| | | | | | | | | | DAI) | |
| 6 | 7 (code d) | 7 (code d) | | | | 7 (code d) | 7 (code d) | | | 5 (code d) |

The “UL-DAI” inside parentheses in Table 8-2 indicates that the code words of the UL-DAI function as the UL-DAI in the LTE and LTE-A. The “new UL-DAI” inside parentheses indicates that the code words of UL-DAI function as the “new UL-DAI” defined in Table 5-0, Table 5-0-1, Table 5-0-2, or Table 5-0-3.

The time sequence of the configurations 1-5 in Table 8-2 is arranged in a row, as shown in Table 8-2-1.

TABLE 8-2-1

| serial | | | | | | | | | | |
|---|---|---|---|---|---|---|---|---|---|---|
| number of | downlink subframe index n | | | | | | | | | |
| configuration | 0 | 1 | 2 | 3 | 4 | 5 | 6 | 7 | 8 | 9 |
| 0 | 4 (code a), | 6 (code a), | | | | 4 (code a), | 6 (code a), | | | |
| | or | or | | | | or | or | | | |
| | 7 (code b) | 7 (code b) | | | | 7 (code b | 7 (code b) | | | |
| 1-5 | 4 (code c) | 6 (code c) | | 4 (UL- | 4 (UL- | | 6 (code c) | | 4 (UL- | 4 (new UL- |
| | | | | DAI) | DAI) | | | | DAI) | DAI) |
| 6 | 7 (code d) | 7 (code d) | | | | 7 (code d) | 7 (code d) | | | 5 (code d) |

After determining the reference uplink and downlink configuration according to the above method, the PUSCH data is transmitted in corresponding uplink subframes according to the timing relationship corresponding to the reference uplink and downlink configuration.

Further, exemplary embodiments of the present invention include a step (e.g., step 303 of FIG. 2), which implements the retransmission of the scheduled PUSCH.

Referring again to FIG. 3, at step 303, the UE determines, according to the reference uplink and downlink configuration of the PUSCH determined at step 302, the timing relationship from the PUSCH to the PHICH that is defined in the LTE and LTE-A; receives, according to the timing relationship, the PHICH of the PUSCH that is scheduled at step 302 and transmitted by the base station, or receives, according to the timing relationship, the retransmission indication of the UL-Grant transmitted by the base station. The UE retransmits the PUSCH scheduled at step 302 according to the PHICH or the retransmission indication of the UL Grant, and according to the timing relationship determined at step 302 or the timing relationship carried by the UL grant for indicating retransmission.

According to the reference uplink and downlink configuration determined in step 302, the timing relationship from the PUSCH to the PHICH that is defined in the LTE and LTE-A is determined. The base station transmits, according to the timing relationship, the PHICH of the PUSCH scheduled in step 302 and the HARQ-ACK information for carrying the PUSCH, or transmits the retransmission indication of the UL-Grant according to the timing relationship. The UE receives, according to the timing relationship, the PHICH or the retransmission indication of the UL-Grant that is transmitted by the base station.

As can be seen from Table 2-3, for the same downlink subframes, the timing relationships from the PUSCH to the PHICH that correspond to the configuration 1-5 are the same. Accordingly, the reference uplink and downlink configuration determined according to the above method may uniquely correspond to a timing relationship in this step. For the configuration 0, regardless of whether the reference uplink and downlink configuration determined at step 302 is the type I of the configuration 0 or the type II of the configuration 0, according to the location of the subframe where the PUSCH in the type I or type II is located, and according to the timing relationship from the PUSCH to the PHICH under the uplink and downlink configuration 0 in the LTE and LTE-A, the UE determines the timing relationship from the PUSCH to the PHICH. According to the timing relationship, the UE receives the PHICH or the retransmission indication of the UL-Grant that is transmitted by the base station.

However, as mentioned above, if the base station intends to implement the deleted scheduling in the configuration 0, the base station may implement the scheduling through the scheduling of the same downlink subframes in the configuration 6. Therefore, when this case occurs, the reference uplink and downlink configuration determined by the UE is the configuration 6. Indeed, what the base station is to transmit is the configuration 0. At this time, the base station cannot find an uplink subframe for the PHICH, but may indicate, through the UL-Grant, the UE to retransmit the PUSCH according to the new timing relationship. The new timing relationship is determined according to the bit value of the UL-Index or the UL-DAI in the UL-Grant for indicating retransmission and/or the reference uplink and downlink configuration for retransmitting the PUSCH that is carried in the serial number of subframe where the UL-Grant is located, so as to obtain greater a degree of freedom of resource indication. At the same time, the base station may determine, according to the requirements, to indicate retransmission through the PHICH or the UL-Grant.

If the base station transmits one PHICH in the PHICH subframe of the PUSCH scheduled at step 302, then when the PHICH is NACK, the UE retransmits the PUSCH scheduled at step 302 according to the timing relationship from the PHICH to the PUSCH under the reference uplink and downlink configuration determined at step 302.

If the base station transmits one UL Grant in the PHICH subframe of the PUSCH scheduled at step 302, then when new data is to be transmitted, a New Data Indicator (NDI) indicates “changed”, the UE determines the reference uplink and downlink configuration and the related timing relationship of new PUSCH according to the location of the UL-Grant or the bit value of the UL-Index or UL-DAI and according to the process of step 302, and transmits the new PUSCH. When the data is to be retransmitted, the UL-Grant indicates retransmission, which is referred to as retransmission UL-Grant. The new NDI indicates “unchanged”, and the UE retransmits the PUSCH scheduled at step 302, the timing relationship between the retransmission UL-Grant and the retransmitted PUSCH follows the timing relation of the reference uplink and downlink configuration indicated by the retransmission UL-Grant, where the reference uplink and downlink configuration is still determined according to the method described at step 302.

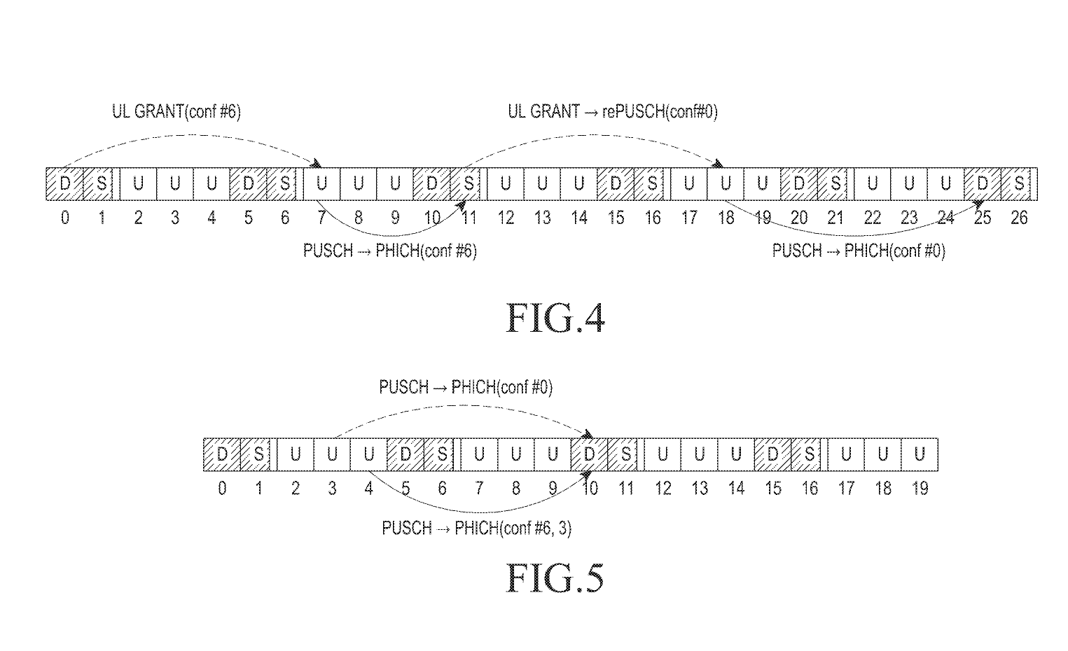

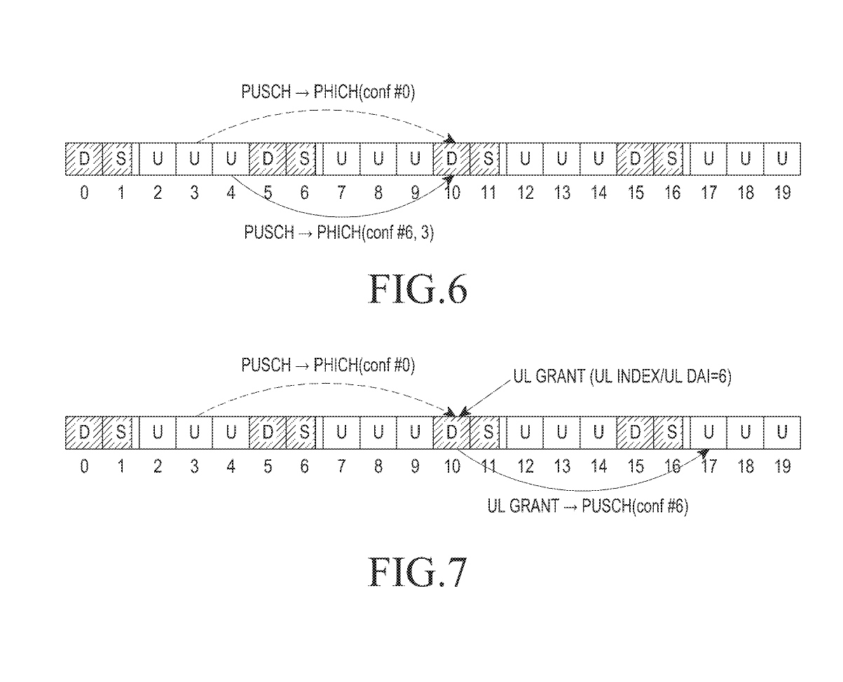

FIG. 4 is a schematic diagram illustrating a synchronous HARQ timing relationship of PUSCH that is determined according to a location of a UL-Grant and illustrating a retransmission of PUSCH according to an exemplary embodiment of the present invention. FIG. 5 is a schematic diagram illustrating an example that a PUSCH of two uplink subframes returns Physical Hybrid-ARQ Indicator Channels (PHICHs) or indicates retransmission in one downlink subframe according to an exemplary embodiment of the present invention. FIG. 6 is a schematic diagram illustrating an example that a PUSCH of two uplink subframes indicates retransmission in one downlink subframe according to an exemplary embodiment of the present invention. FIG. 7 is a schematic diagram illustrating an example in which a PUSCH of two uplink subframes indicates retransmission in one downlink subframe according to an exemplary embodiment of the present invention.

Referring to FIG. 4, in the 0^{th} subframe, the UE detects the UL-Grant, and detects that the bit value of the UL-Index or UL-DAI in the UL-Grant is d. The UE applies the time sequence of the configuration 6, and schedules the PUSCH in the (0+7)th subframe according to Table 4-2 or 4-1. Afterwards, the base station applies the time sequence of the configuration 6, and transmits the PHICH of the 7^{th} subframe PUSCH or indicates retransmission through the UL-Grant in the 11^{th} subframe according to the timing relationship from the PUSCH to the PHICH defined in the LTE and LTE-A. In FIG. 4, the base station transmits the UL-Grant information in the 11^{th} subframe, and the UE detects the UL-Grant information and reads the NDI which indicates “unchanged”. If the UL-Index or UL-DAI indicates the configuration 0, the UE retransmits the PUSCH in the 18^{th} subframe according to the time sequence of the configuration 0 in Table 4-2 or 4-1, and then the base station transmits the PHICH or the UL-Grant in the 25^{th} subframe according to the time sequence of the configuration 0 to trigger retransmission.

When the PHICHs of PUSCHs in two different uplink subframes are to be transmitted in one downlink subframe, if the retransmission indication of the UL-Grant is received in the downlink subframe, the UL-Grant may indicate the retransmission of PUSCH in any one of the two uplink subframes. The PUSCHs in the two different uplink subframes are called old PUSCHs.

Referring to FIG. 5, according to the time sequence in Table 4-1, the PHICHs of uplink subframes 3 and 4 are returned in the downlink subframe 10, and the UL-Grant for indicating retransmission in the subframe 10 may indicate the retransmission of the subframe 3 or subframe 4. For a case in which the PHICHs of PUSCHs in two uplink subframes are to be transmitted in one downlink subframe, the UE needs to determine that the received UL-Grant indicates the retransmission of which old PUSCH, and the old PUSCH corresponding to the retransmission the UL-Grant may be determined according to following rules.

1. If the UL-Index or UL-DAI in the retransmission UL-Grant has the same UL-Index or UL-DAI with one of UL-Grants of two old PUSCHs, the UL-Grant of the old PUSCH indicated by the retransmission UL-Grant has the same UL-Index or UL-DAI with the retransmission UL-Grant.

Referring to FIG. 6, according to the time sequence of Table 4-1, the PUSCH is transmitted in the subframe 3, which indicates that the UL-Index or UL-DAI in the UL-Grant of the PUSCH is the uplink and downlink configuration 0. The PHICH of the PUSCH is to be transmitted in the subframe 10. The PUSCH is to be transmitted in the subframe 4, which indicates that the UL-Index or UL-DAI in the UL-Grant of the PUSCH is the uplink and downlink configuration 6. The PHICH of the PUSCH is also to be transmitted in the subframe 10. Suppose the UE receives the UL-Grant indication retransmission in the subframe 10, and the UL-Index or UL-DAI in the UL-Grant is the configuration 6, the UL-Grant indicates the retransmission of the PUSCH in the subframe 4.

2. If only one old PUSCH is to indicate the PHICH or indicate retransmission in the next subframe, the UL-Index or UL-DAI in the retransmission UL-Grant is different from the UL-Index or UL-DAI in the UL-Grant of the old PUSCH. The retransmission UL-Grant indicates the retransmission of the old PUSCH, and applies the configuration indicated by the UL-Index or UL-DAI in the retransmission UL-Grant to implement the timing relationship from the PDCCH to the PUSCH.

Referring to FIG. 7, the PUSCH is to be transmitted in the subframe 3, which indicates that the UL-Index or UL-DAI in the UL-Grant of the PUSCH is the configuration 0. The PHICH of the PUSCH is to be transmitted in the subframe 10. Suppose the UE receives the UL-Grant indication retransmission in the subframe 10, and the UL-Index or UL-DAI in the UL-Grant is the configuration 6, the UL-Grant indicates the retransmission of the PUSCH in the subframe 3, and applies the configuration 6 to implement the timing relationship from the PDCCH to the PUSCH.

If two old PUSCHs transmit their PHICHs in one downlink subframe, and the UL-Grant is used for indicating retransmission in the downlink subframe, for simplicity, the case that the UL-Index or UL-DAI in the UL-Grant is different from the UL-Index or UL-DAI in the two old UL-Grants may not be considered.

Thus, the PUSCH transmission method according to exemplary embodiments of the present invention ends. As can be seen from the above, according to the bit value of the UL-Index or UL-DAI in the PDCCH and/or the serial number of the subframe where the UL-Grant is located, the reference uplink and downlink configuration of the scheduled PUSCH is determined. In this way, the UE can obtain the information of the reference uplink and downlink configuration in time, and determine the timing relationship corresponding to the reference uplink and downlink configuration to perform PUSCH transmission, so as to adapt the rapid switching of TDD uplink and downlink configuration.

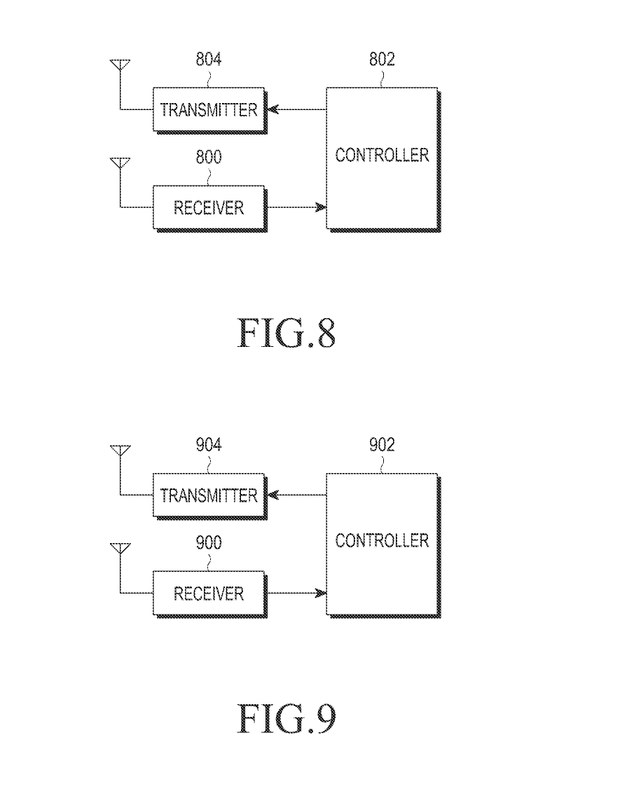

FIG. 8 is a block diagram illustrating a structure of a UE according to an exemplary embodiment of the present invention.

Referring to FIG. 8, the UE includes a receiver 800, a controller 802 and a transmitter 804.

The receiver 800 receives signals and data (e.g., a PDCCH for scheduling PUSCH resources) from the base station.

The controller 802 controls the receiver 800 and the transmitter 804. The controller 802 also performs operations for the UE according to exemplary embodiments of the present invention such as, for example, the operations for the UE in relation to the exemplary embodiments of the present invention described above.

The transmitter 804 transmits signals and data (e.g., PUSCH data) to the base station.

FIG. 9 is a block diagram illustrating a structure of a base station according to an exemplary embodiment of the present invention.

Referring to FIG. 9, the base station includes a receiver 900, a controller 902 and a transmitter 904.

The receiver 900 receives signals and data (i.e PUSCH data) from the UE.

The controller 902 controls the receiver 900 and the transmitter 904. The controller 902 also performs operations for the base station according to exemplary embodiments of the present invention such as, for example, the operations for the base station in relation to the exemplary embodiments of the present invention described above.

The transmitter 904 transmits signals and data (e.g., a PDCCH for scheduling PUSCH resources) to the UE.

It will be appreciated that exemplary embodiments of the present invention according to the claims and description in the specification can be realized in the form of hardware, software or a combination of hardware and software.

Any such software may be stored in a non-transitory computer readable storage medium. The non-transitory computer readable storage medium stores one or more programs (software modules), the one or more programs comprising instructions, which when executed by one or more processors in an electronic device, cause the electronic device to perform a method of the present invention.

Any such software may be stored in the form of volatile or non-volatile storage such as, for example, a storage device like a Read Only Memory (ROM), whether erasable or rewritable or not, or in the form of memory such as, for example, Random Access Memory (RAM), memory chips, device or integrated circuits or on an optically or magnetically readable medium such as, for example, a Compact Disk (CD), Digital Versatile Disc (DVD), magnetic disk or magnetic tape or the like. It will be appreciated that the storage devices and storage media are exemplary embodiments of machine-readable storage that are suitable for storing a program or programs comprising instructions that, when executed, implement exemplary embodiments of the present invention. Accordingly, exemplary embodiments provide a program comprising code for implementing apparatus or a method as claimed in any one of the claims of this specification and a machine-readable storage storing such a program.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for transmitting a Physical Uplink Shared Channel (PUSCH) by a User Equipment (UE) in a traffic adaptation system, the method comprising:
receiving, from a base station, a Physical Downlink Control Channel (PDCCH) for scheduling PUSCH resources;
obtaining an Uplink (UL)-Grant in the PDCCH;
determining a reference uplink and downlink configuration of the scheduled PUSCH resources in the PDCCH, based on at least one of the bit value of a UL-Index or a UL-Downlink Assignment Index (DAI) in the UL-Grant, and a serial number of a subframe in which the UL-Grant is located; and
transmitting PUSCH data on the scheduled PUSCH resources according to a timing relationship corresponding to the reference uplink and downlink configuration.

2. The method of claim 1, wherein a type of the reference uplink and downlink configuration corresponds to one of four types of reference uplink and downlink configurations,
wherein a first type of the four types of uplink and downlink configurations corresponds to a type I of uplink and downlink configuration 0, and the type I corresponds to a scheduling mode of the uplink and downlink configuration 0,
wherein a second type of the four types of uplink and downlink configurations corresponds to uplink and downlink configurations 1-5,
wherein a third type of the four types of uplink and downlink configurations corresponds to uplink and downlink configuration 6,
wherein a fourth type of the four types of uplink and downlink configurations corresponds to a type II of uplink and downlink configuration 0, and the type II corresponds to another scheduling mode of the configuration 0, and
wherein values of bits in the UL-Index or the UL-DAI correspond to the four types, respectively.

3. The method of claim 1, wherein the determining of the reference uplink and downlink configuration of the scheduled PUSCH comprises:
determining the reference uplink and downlink configuration of the scheduled PUSCH according to a relationship between the bit value of the UL-Index or the UL-DAI and the uplink and downlink configuration,
wherein a reference uplink and downlink configuration corresponding to the bit value corresponds to the reference uplink and downlink configuration of the scheduled PUSCH.

4. The method of claim 2, wherein the determining of the reference uplink and downlink configuration of the scheduled PUSCH comprises:
if the UL-Grant is in the 0th, 1st, 5th or 6th subframe:
configuring four values of bits in the UL-Index or UL-DAI to respectively correspond to the four types of reference uplink and downlink configurations; and
determining the reference uplink and downlink configuration of the scheduled PUSCH according to a relationship between the bit value of the UL-Index or UL-DAI and uplink and downlink configuration,
wherein the reference uplink and downlink configuration corresponding to the bit value corresponds to the reference uplink and downlink configuration of the scheduled PUSCH;
if the UL-Grant is in the 3rd, 4th or 8th subframe, determining that the reference uplink and downlink configuration is the configurations 1-5; and
if the UL-Grant is in the 9th subframe,
when the bit value of the UL-Index or UL-DAI is a first value determining that the reference uplink and downlink configuration is the uplink and downlink configuration 6; and
when the bit value of the UL-Index or UL-DAI is not the first value, determining that the reference uplink and downlink configuration is the uplink and downlink configurations 1-5.

5. The method of claim 2, wherein if the type of the reference uplink and downlink configuration is the type I, the scheduling mode of the uplink and downlink configuration 0 corresponding to the type I comprises a scheduling mode for scheduling a PUSCH of the (n+k)^{th} subframe to the UE, and
wherein if the type of the reference uplink and downlink configuration is the type II, the scheduling mode of the uplink and downlink configuration 0 corresponding to the type II comprises a scheduling mode for scheduling a PUSCH of the (n+7)^{th} subframe to the UE,
wherein n is a downlink subframe for transmitting the PDCCH, and a value of k is determined according to a following table:

| serial | | | | | | | | | | |
|---|---|---|---|---|---|---|---|---|---|---|
| number of | downlink subframe index n | | | | | | | | | |
| configuration | 0 | 1 | 2 | 3 | 4 | 5 | 6 | 7 | 8 | 9 |
| | | | | |
|---|---|---|---|---|
| 0 | 4 | 6 | 4 | 6 |

6. The method of claim 2, wherein, if the type of the reference uplink and downlink configuration is the type I, the scheduling mode of the uplink and downlink configuration 0 corresponding to the type I comprises scheduling a PUSCH of the (n+k)^{th} subframe to the UE,
wherein if the type of the reference uplink and downlink configuration is the type II, the scheduling mode of the uplink and downlink configuration 0 corresponding to the type II comprises a scheduling mode for scheduling a PUSCH of the (n+k)^{th} and the (n+7)^{th} subframes to the UE, and
wherein n is a downlink subframe for transmitting the PDCCH, and the value of k is determined according to a following table:

| serial | | | | | | | | | | |
|---|---|---|---|---|---|---|---|---|---|---|
| number of | downlink subframe index n | | | | | | | | | |
| configuration | 0 | 1 | 2 | 3 | 4 | 5 | 6 | 7 | 8 | 9 |
| | | | | |
|---|---|---|---|---|
| 0 | 4 | 6 | 4 | 6 |

7. The method of claim 2, wherein if the type of the reference uplink and downlink configuration is the type I, the scheduling mode of the uplink and downlink configuration 0 corresponding to the type I comprises a scheduling mode for scheduling a PUSCH of the (n+k)^{th} subframe to the UE,
wherein if the type of the reference uplink and downlink configuration is the type II, the scheduling mode of the uplink and downlink configuration 0 corresponding to the type II comprises a scheduling mode for, when n=0 or 5, scheduling a PUSCH of the (n+k)^{th} and the (n+7)^{th} subframes to the UE, and a scheduling mode for, when n=1 or 6, scheduling a PUSCH of the (n+k)^{th} and (n+6)^{th} subframes to the UE, and
wherein n is a downlink subframe for transmitting the PDCCH, and a value of k is determined according to a following table:

| serial | | | | | | | | | | |
|---|---|---|---|---|---|---|---|---|---|---|
| number of | downlink subframe index n | | | | | | | | | |
| configuration | 0 | 1 | 2 | 3 | 4 | 5 | 6 | 7 | 8 | 9 |
| | | | | |
|---|---|---|---|---|
| 0 | 4 | 7 | 4 | 7 |

8. The method of claim 2, wherein the timing relationship corresponding to the second type of reference uplink and downlink configuration corresponds to transmitting the PUSCH on the (n+k)^{th} subframe, and
wherein n is a downlink subframe for transmitting the PDCCH, and a value of k is determined according to a following table:

| serial | | | | | | | | | | |
|---|---|---|---|---|---|---|---|---|---|---|
| number of | downlink subframe index n | | | | | | | | | |
| configuration | 0 | 1 | 2 | 3 | 4 | 5 | 6 | 7 | 8 | 9 |
| 1-5 | 4 | 6 | | 4 | 4 | | 6 | | 4 | 4 |

9. The method of claim 2, wherein the timing relationship corresponding to the third type of reference uplink and downlink configuration corresponds to transmitting the PUSCH on the (n+k)^{th} subframe, and
wherein n is a downlink subframe for transmitting the PDCCH, and a value of k is determined according to a following table:

| serial | | | | | | | | | | |
|---|---|---|---|---|---|---|---|---|---|---|
| number of | downlink subframe index n | | | | | | | | | |
| configuration | 0 | 1 | 2 | 3 | 4 | 5 | 6 | 7 | 8 | 9 |
| 6 | 7 | 7 | | | | 7 | 7 | | | 5 |

10. The method of claim 4, wherein if the UL-Grant is in the 3^{th}, 4^{th} or 8^{th} subframe, the bit value of the UL-Index or the UL-DAI is used for indicating the number of Physical Downlink Shared Channel (PDSCH) transmission subframes to be returned by the subframe where the PUSCH is located, and
wherein if the UL-Grant is in the 9^{th} subframe, and the bit value of the UL-Index or the UL-DAI is not the first value, the bit value of the UL-Index or the UL-DAI is used for indicating the number of PDSCH transmission subframes to be returned by the subframe where the PUSCH is located.

11. The method of claim 1, further comprising:
determining a timing relationship from the PUSCH to a Physical Hybrid-ARQ Indicator Channel (PHICH) according to the reference uplink and downlink configuration;
receiving the PHICH or an UL-Grant for indicating retransmission that is transmitted by the base station according to the timing relationship;
when detecting the UL-Grant in the PHICH subframe, and when a new data indication bit of the UL-Grant indicates one of “changed” and “unchanged”, determining the reference uplink and downlink configuration of the scheduled PUSCH in the PDCCH, wherein the UL-Index or the UL-DAI is the UL-Index or the UL-DAI in the UL Grant for indicating retransmission, and the UL-Grant is the UL Grant for indicating retransmission, and transmitting PUSCH data to be retransmitted when transmitting the PUSCH data; and
when detecting “NACK” in the PHICH subframe, determining a timing relationship from the PHICH to the PUSCH according to the reference uplink and downlink configuration, and retransmitting the PUSCH data according to the timing relationship from the PHICH to the PUSCH.

12. The method of claim 11, wherein when the PHICH subframe corresponds to two old PUSCHs in different uplink subframes, the new data indication bit of the UL-Grant that is located in the same subframe as the PHICH indicates “unchanged”, and the determined reference uplink and downlink configuration is the same as the reference uplink and downlink configuration determined when one of the old PUSCHs is scheduled, and the retransmitted PUSCH data is data of the old PUSCHs.

13. A User Equipment (UE) for transmitting a Physical Uplink Shared Channel (PUSCH) in a traffic adaptation system, the UE comprising:
a receiver for receiving, from a base station, a Physical Downlink Control Channel (PDCCH) for scheduling PUSCH resources;
a controller for obtaining an Uplink (UL)-Grant in the PDCCH, and determining a reference uplink and downlink configuration of the scheduled PUSCH resources in the PDCCH, based on at least one of the bit value of a UL-Index or a UL-Downlink Assignment Index (DAI) in the UL-Grant, and a serial number of a subframe in which the UL-Grant is located; and
a transmitter for transmitting PUSCH data on the scheduled PUSCH resources according to a timing relationship corresponding to the reference uplink and downlink configuration.

14. The UE of claim 13, wherein a type of the reference uplink and downlink configuration is one of four types of reference uplink and downlink configurations,
wherein a first type of the four types of uplink and downlink configurations corresponds to a type I of uplink and downlink configuration 0, and the type I corresponds to a scheduling mode of the uplink and downlink configuration 0;
wherein a second type of the four types of uplink and downlink configurations corresponds to uplink and downlink configurations 1-5;
wherein a third type of the four types of uplink and downlink configurations corresponds to uplink and downlink configuration 6;
wherein a fourth type of the four types of uplink and downlink configurations corresponds to a type II of uplink and downlink configuration 0, and the type II corresponds to another scheduling mode of the configuration 0, and
wherein values of bits in the UL-Index or the UL-DAI correspond to the four types, respectively.

15. The UE of claim 13, wherein the controller determines the reference uplink and downlink configuration of the scheduled PUSCH according to a relationship between the bit value of the UL-Index or the UL-DAI and the uplink and downlink configuration, wherein a reference uplink and downlink configuration corresponding to the bit value corresponds to the reference uplink and downlink configuration of the scheduled PUSCH resources.

16. The UE of claim 14, wherein if the UL-Grant is in the 0^{th}, 1^{st}, 5^{th} or 6^{th} subframe, the controller configures four values of bits in the UL-Index or UL-DAI to respectively correspond to the four types of reference uplink and downlink configurations, and determines the reference uplink and downlink configuration of the scheduled PUSCH according to a relationship between the bit value of the UL-Index or UL-DAI and uplink and downlink configuration, and determines that the reference uplink and downlink configuration corresponding to the bit value corresponds to the reference uplink and downlink configuration of the scheduled PUSCH,
wherein if the UL-Grant is in the 3^{rd}, 4^{th} or 8^{th} subframe, the controller determines that the reference uplink and downlink configuration is the configurations 1-5,
wherein if the UL-Grant is in the 9^{th} subframe, and the bit value of the UL-Index or UL-DAI is a first value, the controller determines that the reference uplink and downlink configuration is the uplink and downlink configuration 6 and
wherein if the UL-Grant is in the 9^{th} subframe, and the bit value of the UL-Index or UL-DAI is not the first value, the controller determines that the reference uplink and downlink configuration is the uplink and downlink configurations 1-5.

17. The UE of claim 14, wherein if the type of the reference uplink and downlink configuration is the type I, the scheduling mode of the uplink and downlink configuration 0 corresponding to the type I comprises a scheduling mode for scheduling a PUSCH of the (n+k)^{th} subframe to the UE, and
wherein if the type of the reference uplink and downlink configuration is the type II, the scheduling mode of the uplink and downlink configuration 0 corresponding to the type II comprises a scheduling mode for scheduling a PUSCH of the (n+7)^{th} subframe to the UE,
wherein n is a downlink subframe for transmitting the PDCCH, and a value of k is determined according to a following table:

| serial | | | | | | | | | | |
|---|---|---|---|---|---|---|---|---|---|---|
| number of | downlink subframe index n | | | | | | | | | |
| configuration | 0 | 1 | 2 | 3 | 4 | 5 | 6 | 7 | 8 | 9 |
| | | | | |
|---|---|---|---|---|
| 0 | 4 | 6 | 4 | 6 |

18. The UE of claim 14, wherein, if the type of the reference uplink and downlink configuration is the type I, the scheduling mode of the uplink and downlink configuration 0 corresponding to the type I comprises scheduling a PUSCH of the (n+k)^{th} subframe to the UE, and
wherein if the type of the reference uplink and downlink configuration is the type II, the scheduling mode of the uplink and downlink configuration 0 corresponding to the type II comprises a scheduling mode for scheduling a PUSCH of the (n+k)^{th} and the (n+7)^{th} subframes to the UE, and
wherein n is a downlink subframe for transmitting the PDCCH, and the value of k is determined according to a following table:

| serial | | | | | | | | | | |
|---|---|---|---|---|---|---|---|---|---|---|
| number of | downlink subframe index n | | | | | | | | | |
| configuration | 0 | 1 | 2 | 3 | 4 | 5 | 6 | 7 | 8 | 9 |
| | | | | |
|---|---|---|---|---|
| 0 | 4 | 6 | 4 | 6 |

19. The UE of claim 14, wherein if the type of the reference uplink and downlink configuration is the type I, the scheduling mode of the uplink and downlink configuration 0 corresponding to the type I comprises a scheduling mode for scheduling a PUSCH of the (n+k)^{th} subframe to the UE,
wherein if the type of the reference uplink and downlink configuration is the type II, the scheduling mode of the uplink and downlink configuration 0 corresponding to the type II comprises a scheduling mode for, when n=0 or 5, scheduling a PUSCH of the (n+k)^{th} and the (n+7)^{th} subframes to the UE, and a scheduling mode for, when n=1 or 6, scheduling a PUSCH of the (n+k)^{th} and (n+6)^{th} subframes to the UE, and
wherein n is a downlink subframe for transmitting the PDCCH, and a value of k is determined according to a following table:

| serial | | | | | | | | | | |
|---|---|---|---|---|---|---|---|---|---|---|
| number of | downlink subframe index n | | | | | | | | | |
| configuration | 0 | 1 | 2 | 3 | 4 | 5 | 6 | 7 | 8 | 9 |
| | | | | |
|---|---|---|---|---|
| 0 | 4 | 7 | 4 | 7 |

20. The UE of claim 14, wherein the timing relationship corresponding to the second type of reference uplink and downlink configuration corresponds to transmitting the PUSCH on the (n+k)^{th} subframe, and
wherein n is a downlink subframe for transmitting the PDCCH, and a value of k is determined according to a following table:

| serial | | | | | | | | | | |
|---|---|---|---|---|---|---|---|---|---|---|
| number of | downlink subframe index n | | | | | | | | | |
| configuration | 0 | 1 | 2 | 3 | 4 | 5 | 6 | 7 | 8 | 9 |
| 1-5 | 4 | 6 | | 4 | 4 | | 6 | | 4 | 4 |

21. The UE of claim 14, wherein the timing relationship corresponding to the third type of reference uplink and downlink configuration corresponds to transmitting the PUSCH on the (n+k)^{th} subframe, and
wherein n is a downlink subframe for transmitting the PDCCH, and a value of k is determined according to a following table:

| serial | | | | | | | | | | |
|---|---|---|---|---|---|---|---|---|---|---|
| number of | downlink subframe index n | | | | | | | | | |
| configuration | 0 | 1 | 2 | 3 | 4 | 5 | 6 | 7 | 8 | 9 |
| 6 | 7 | 7 | | | | 7 | 7 | | | 5 |

22. The UE of claim 16, wherein if the UL-Grant is in the 3^{th}, 4^{th} or 8^{th} subframe, the bit value of the UL-Index or the UL-DAI is used for indicating the number of Physical Downlink Shared Channel (PDSCH) transmission subframes to be returned by the subframe where the PUSCH is located, and
wherein if the UL-Grant is in the 9^{th} subframe, and the bit value of the UL-Index or the UL-DAI is not the first value, then the bit value of the UL-Index or the UL-DAI is used for indicating the number of PDSCH transmission subframes to be returned by the subframe where the PUSCH is located.

23. The UE of claim 13, wherein the controller determines a timing relationship from the PUSCH to a Physical Hybrid-ARQ Indicator Channel (PHICH) according to the reference uplink and downlink configuration, and the receiver receives the PHICH or an UL Grant for indicating retransmission that is transmitted by the base station according to the timing relationship,
wherein when detecting the UL-Grant in the PHICH subframe, and if a new data indication bit of the UL-Grant indicates one of “changed” and “unchanged”, the controller determines the reference uplink and downlink configuration of the scheduled PUSCH resources in the PDCCH, wherein the UL-Index or the UL-DAI is the UL-Index or the UL-DAI in the UL Grant for indicating retransmission, and the UL-Grant is the UL Grant for indicating retransmission, and the transmitter transmits PUSCH data to be retransmitted when transmitting the PUSCH data, and
wherein when detecting “NACK” in the PHICH subframe, the controller determines a timing relationship from the PHICH to the PUSCH according to the reference uplink and downlink configuration, and the transmitter retransmits the PUSCH data according to the timing relationship from the PHICH to the PUSCH.

24. The UE of claim 23, wherein when the PHICH subframe corresponds to two old PUSCHs in different uplink subframes, the new data indication bit of the UL-Grant that is located in the same subframe as the PHICH indicates “unchanged”, and the determined reference uplink and downlink configuration is the same as the reference uplink and downlink configuration determined when one of the old PUSCHs is scheduled, the retransmitted PUSCH data is data of the old PUSCHs.
